(19) United States
(12) Patent Application Publication
(10) Pub. No.: US 2026/0311106 A1
(43) Pub. Date: Oct. 8, 2026

(54) AI SYSTEM FOR INTERMODAL LOGISTICS ORCHESTRATION

(71) Applicant: Kaydon A. STANZIONE, Sewell, NJ (US)

(72) Inventor: Kaydon A. STANZIONE, Sewell, NJ (US)

(21) Appl. No.: 19/638,740

(22) Filed: Apr. 3, 2026

Related U.S. Application Data
(60) Provisional application No. 63/783,495, filed on Apr. 4, 2025.

(51) Int. Cl. G06Q 10/083

(52) U.S. Cl. CPC G06Q 10/083

(57) ABSTRACT

A method and system for autonomous orchestration of intermodal logistics transportation. A processing server receives a shipping order from a user device over a communication network, the shipping order including a payload specification, scheduling data, origin and destination data, and shipment preference data. An attributes engine extracts and classifies the order information. A modality engine analyzes the classified order data and determines recommended transport carrier modalities. A manifest engine generates a transit profile for each recommended modality including the origin, destination, and intermediate stops. A first AI engine processes each transit profile with corresponding real-time data by inputting the recommended modalities and real-time data into a trained AI model that outputs an optimized payload transport solution for each modality. The processing server compares each optimized payload transport solution to the shipping order and generates an optimized logistics solution including transport carrier assignments, routing instructions, and scheduling parameters.

### CROSS REFERENCE TO RELATED APPLICATION

This application claims the benefit of priority of U.S. provisional application number 63/783,495, filed Apr. 4, 2025, the contents of which are herein incorporated by reference in their entirety.

### FIELD

The present disclosure relates generally to automated logistics management and intermodal transportation orchestration, and more specifically to systems and methods for integrating artificial intelligence throughout an end-to-end supply chain to autonomously orchestrate the transportation of payloads across traditional and transformative electric and sustainable land, air, and water vehicles using real-time data processing, IoT-enabled vehicle control, and influence-variable matrix optimization.

### BACKGROUND

Orchestrated logistics involves coordinating the movement of people and goods through multiple transportation modalities. Stakeholders across the supply chain, e.g., shippers, brokers, Third and Fourth Party Logistic supply chain models (3PLs, 4PLs), warehousing operators, carriers, receivers, etc., require systems that integrate digital data processing with advanced computational techniques to plan, schedule, and execute logistics operations across diverse carrier networks while minimizing manual intervention, reducing delivery delays, and controlling costs.

Conventional logistics systems fall short of these requirements in several respects. First, conventional systems depend on substantial manual oversight at each stage from order placement through enroute management, introducing inefficiencies, errors, and delays that propagate through the supply chain and struggle to keep pace with changes in market demand, environmental conditions, and regulatory requirements. Second, conventional systems lack robust AI engines capable of properly deploying advanced mathematical solutions to intermodal optimization problems. Many existing solutions fail to properly classify deterministic and stochastic environments, and the improper selection of influence parameters within the transportation chain introduces cascading errors in mathematical modeling that produce suboptimal carrier assignments, routing, and scheduling. Third, conventional systems cannot effectively integrate large volumes of real-time data from heterogeneous sources such as traffic monitoring systems, vehicle telematics, environmental sensors, and regulatory databases. In particular, conventional systems lack mechanisms for receiving real-time operational data from IoT devices interfaced with vehicle electronic control units, identifying deviations between active transit profiles and client requirements, and autonomously generating and transmitting corrective routing actions to transport vehicles-capabilities essential for responding to incipient vehicle failures, infrastructure disruptions, and contested logistics scenarios. Fourth, conventional systems cannot orchestrate maximum capacity loading across intermodal transport fleets. Building a single maximum capacity load can take days of human effort, and this complexity compounds when optimizing across a fleet of heterogeneous traditional and transformative vehicles. Existing systems lack the computational architecture to sequentially evaluate load tenders for compatibility, impose progressively deterministic boundary conditions, and autonomously generate optimized manifests. Fifth, conventional systems lack computational feedback loops that funnel resulting operational data back into generative machine-learning datasets for model retraining and that provide real-time adjustments to resolve unforeseen contingencies, preventing continuous improvement of predictive analytics and proactive correction of deviations during active transit.

Thus, there is a need for a system that unifies data analytics, automated decision-making, and real-time vehicle control into a comprehensive, autonomous logistics orchestration platform.

### SUMMARY

In some aspects, the techniques described herein relate to a method for autonomous orchestration of intermodal logistics transportation, including: receiving, by a processing server from a user device via a user interface over a communication network, a shipping order including order data, the order data including at least a payload specification for a payload, shipment scheduling data, payload origin data, payload destination data, and payload shipment preference data; extracting and classifying, by an attributes engine of the processing server, the received order information; analyzing, by a modality engine of the processing server, the extracted and classified order data and determining one or more recommended transport carrier modalities for transporting the payload; generating, by a manifest engine of the processing server, a transit profile for each of the one or more recommended transport carrier modalities, wherein the transit profile includes at least the payload origin, the payload destination, and one or more intermediate stops; processing, by a first Artificial Intelligence (AI) Engine, the transit profile for each of the one or more recommended transport carrier modalities with corresponding real-time data for each of the one or more recommended transport carrier modalities, the real-time data including at least transport carrier modality demographics, traffic patterns, and regulatory inputs, the processing by the AI Engine including: inputting, by the processing server, the one or more recommended transport carrier modalities with the corresponding real-time data into a trained AI model configured to output an optimized payload transport solution for each of the one or more recommended transport carrier modalities; outputting, by the trained AI model, an optimized payload transport solution for each of the one or more recommended transport carrier modalities; comparing, by the processing server, the optimized payload transport solution for each of the one or more recommended transport carrier modalities to the shipping order; and generating, by the processing server, an optimized logistics solution for the payload, the optimized logistics solution including at least transport carrier assignments, routing instructions, and scheduling parameters.

In some aspects, the techniques described herein relate to a system for autonomous orchestration of intermodal logistics transportation, including: a communication network; a user device configured to transmit, via the communication network, a shipping order including order data, the order data including at least a payload specification for a payload, shipment scheduling data, payload origin data, payload destination data, and payload shipment preference data; a processing server communicatively coupled to the user device via the communication network, the processing server comprising one or more processors and one or more non-transitory computer-readable storage media storing instructions that, when executed by the one or more processors, cause the processing server to: receive, from the user device via a user interface over the communication network, the shipping order; extract and classify, by an attributes engine executed by the one or more processors, the received order information; analyze, by a modality engine executed by the one or more processors, the extracted and classified order data and determine one or more recommended transport carrier modalities for transporting the payload; generate, by a manifest engine executed by the one or more processors, a transit profile for each of the one or more recommended transport carrier modalities, wherein the transit profile includes at least the payload origin, the payload destination, and one or more intermediate stops; process, by a first Artificial Intelligence (AI) Engine executed by the one or more processors, the transit profile for each of the one or more recommended transport carrier modalities with corresponding real-time data for each of the one or more recommended transport carrier modalities, the real-time data including at least transport carrier modality demographics, traffic patterns, and regulatory inputs, the processing by the first AI Engine comprising: inputting the one or more recommended transport carrier modalities with the corresponding real-time data into a trained AI model stored on the one or more non-transitory computer-readable storage media, the trained AI model configured to output an optimized payload transport solution for each of the one or more recommended transport carrier modalities; outputting, by the trained AI model, an optimized payload transport solution for each of the one or more recommended transport carrier modalities; comparing the optimized payload transport solution for each of the one or more recommended transport carrier modalities to the shipping order; and generating an optimized logistics solution for the payload, the optimized logistics solution including at least transport carrier assignments, routing instructions, and scheduling parameters; and a database communicatively coupled to the processing server and configured to store the shipping order, the transit profile, the trained AI model, and the optimized logistics solution.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for autonomous orchestration of intermodal logistics transportation in accordance with exemplary embodiments;

FIG. 2A is a block diagram illustrating the processing server in the system of FIG. 1 for autonomous orchestration of intermodal logistics transportation in accordance with exemplary embodiments;

FIGS. 2B-2C are block diagrams illustrating a logistics optimization program executed by the processing server of FIG. 2A in accordance with exemplary embodiments;

FIG. 2D is a block diagram illustrating AI Engine core processing components in accordance with exemplary embodiments;

FIG. 2E is a block diagram illustrating a computational feedback loop in accordance with exemplary embodiments;

FIGS. 3A-3B is a flow diagram illustrating a process for autonomous orchestration of intermodal logistics transportation in the system of FIG. 1 in accordance with exemplary embodiments;

FIGS. 4A-4B are a flow chart illustrating an exemplary method for autonomous orchestration of intermodal logistics transportation in accordance with exemplary embodiments; and

FIG. 5 is a block diagram illustrating a computer system architecture in accordance with exemplary embodiments. Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

The methods and systems disclosed herein provide for an artificial intelligence-powered logistics orchestration system that autonomously manages the end-to-end planning, coordination, and execution of intermodal payload transportation across traditional and transformative electric and sustainable land, air, and water vehicles. The presently disclosed methods and systems address the deficiencies of conventional logistics management by providing a processing server that receives a shipping order from a user device, extracts and classifies order parameters via an attributes engine, determines recommended transport carrier modalities via a modality engine, generates transit profiles via a manifest engine, and processes the transit profiles with corresponding real-time data through a trained AI model that outputs optimized payload transport solutions for each recommended modality. The processing server compares each optimized payload transport solution to the shipping order and generates an optimized logistics solution comprising transport carrier assignments, routing instructions, and scheduling parameters. The presently disclosed methods and systems further provide for a Transport Gap Engine that computationally identifies legs of a transit profile for which no single carrier modality can provide transport service and generates intermodal transfer solutions that assign replacement carrier modalities while optimizing for minimum schedule delay and minimum cost. The presently disclosed methods and systems further provide for enroute dynamic correction in which IoT devices physically interfaced with electronic control units of transport vehicles transmit real-time operational data to the processing server, where a second AI Engine decomposes the operational data into influence-variable matrices, identifies logistics gap conditions by pattern recognition, and generates corrective routing actions that are transmitted back to the transport vehicle as electronic control signals, enabling closed-loop autonomous vehicle operations including Beyond Visual Line of Sight capabilities. The presently disclosed methods and systems further provide for a computational feedback loop that feeds resulting operational data from executed logistics solutions back into the trained AI model for retraining, thereby continuously improving predictive accuracy and enabling proactive corrections that automatically resolve unforeseen contingencies including contested logistics scenarios. Accordingly, the methods and systems disclosed herein provide a comprehensive, autonomous logistics orchestration platform that reduces costs, improves operational efficiency, and minimizes human intervention throughout the supply chain while dynamically adapting to changing environmental and operational conditions in real time.

### GLOSSARY

A “transport carrier modality” may generally refer to a category of transport vehicle defined by its mode of conveyance and energy source. Transport carrier modalities may include, but are not limited to, crewed and autonomous land vehicles (e.g., trucks, rail cars, electric vans), aircraft (e.g., cargo planes, drones, electric vertical takeoff and landing vehicles), watercraft (e.g., cargo ships, barges, autonomous surface vessels), and other conveyance types including human couriers, human-powered craft, autonomous vehicles, and off-road vehicles. A transport carrier modality may be further characterized by attributes such as energy type (e.g., battery, fossil fuel, fuel cell, sustainable aviation fuel), speed, payload volume capacity, payload weight capacity, operational range, and environmental requirements.

A “transit profile” may generally refer to a data structure representing a planned route for transporting a payload from an origin to a destination via one or more intermediate stops. A transit profile may include, for each leg of the route, an assigned transport carrier modality, estimated transit times, operator hours-of-service constraints, energy management parameters, infrastructure requirements, and environmental requirements. A transit profile may be stored in a database of a processing server and may be updated dynamically during transit in response to corrective routing actions.

A “shipping order” may generally refer to a structured data record comprising client requirements for the transportation of a payload. A shipping order may include at least a payload specification (e.g., weight, dimensions, volume, commodity type, hazardous material classification), shipment scheduling data (e.g., pickup date and time, delivery date and time, delivery time windows), payload origin data (e.g., origin address, origin geocoordinates, origin facility type), payload destination data (e.g., destination address, destination geocoordinates, destination facility type), and payload shipment preference data (e.g., carrier preferences, modality preferences, cost constraints, service level requirements, accessorial requirements).

A “payload” may generally refer to one or more persons and/or one or more goods to be transported from an origin to a destination via the system 100. A payload comprising goods may include, but is not limited to, raw materials, manufactured products, perishable goods, luggage, pharmaceutical products, hazardous materials, livestock, mail and parcels, bulk commodities, and containerized freight, etc. A payload comprising one or more persons may include, but is not limited to, individual passengers, groups of passengers, and passengers with accompanying personal effects or mobility equipment. A payload may be further characterized by attributes including weight, dimensions, volume, commodity type, hazardous material classification, temperature and environmental sensitivity requirements, special handling requirements, and any regulatory classifications that influence transport carrier modality selection, routing, and scheduling.

A “logistics gap condition” may generally refer to a detected deviation between an active transit profile and one or more requirements of a shipping order during transit execution. A logistics gap condition may comprise at least one of a schedule deviation, an infrastructure constraint, an incipient vehicle failure, an environmental disruption, or a contested logistics scenario in which an adversarial disruption, delay, or discontinuation of any portion of the supply chain is detected. A logistics gap condition may be identified by pattern recognition applied to influence-variable matrices derived from real-time operational data.

An “influence-variable matrix” may generally refer to a data structure produced by decomposing real-time data into a segmented mathematical representation in which rows, columns, or dimensions correspond to operational, environmental, and regulatory parameters that influence logistics outcomes. Influence-variable matrices may be generated using data manipulation techniques such as Singular Value Decomposition, Markov models, and neural networks, and may be used to perform dimensionality reduction, data noise suppression, and pattern recognition within a trained AI model.

A “computing device” may generally refer to a device that includes one or more electronic components (e.g., an integrated chip or circuit) that can communicate with another device or entity. For example, a computing device may include at least one processor coupled to a memory that stores instructions or code for execution by the processor, and may include a communication interface that allows the computing device to interact with other entities. A computing device can be a portable computing device that can be transported and operated by a user. A portable computing device may provide remote communication capabilities to a network. The portable computing device can be configured to transmit and receive data or communications to and from other devices. A portable computing device may be in the form of a mobile device such as a mobile phone (e.g., smart phone, cellular phone, etc.), tablets, portable media player, personal digital assistant devices (PDAs), wearable device (e.g., watch, bracelet, ring, eyeglasses, health monitoring device such as a fitness tracker, etc.), electronic reader device, etc., or in the form of a card (e.g., smart card) or a fob, etc. Examples of portable computing devices may also include portable computers (e.g., laptops, netbooks, ultrabooks, etc.). A portable computing device may also be in the form of a vehicle (e.g., an automobile), or be integrated as part of a vehicle (e.g., an infosystem of a vehicle). Other examples of computing devices may include Internet of Things (IoT) devices, smart appliances and electronics, gaming consoles, etc. A computing device may also include multiple devices or components (e.g., when a device has remote access to a network by tethering to another device-both devices taken together may be considered a computing device).

A “server computer” may generally refer to a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

A “communication network” may generally refer to any suitable network configuration enabling communications between one or more computing devices. A communication network may include, but is not limited to, a local area network (LAN), a wide area network (WAN), a wireless network (e.g., Wi-Fi), a mobile communication network (e.g., 4G/5G cellular), a satellite network, the Internet, fiber optic networks, coaxial cable networks, infrared links, radio frequency (RF) links, UHF links, Bluetooth links including Bluetooth Low Energy, near-field communication links, or any combination thereof.

### System for Autonomous Orchestration of Intermodal Logistics Transportation

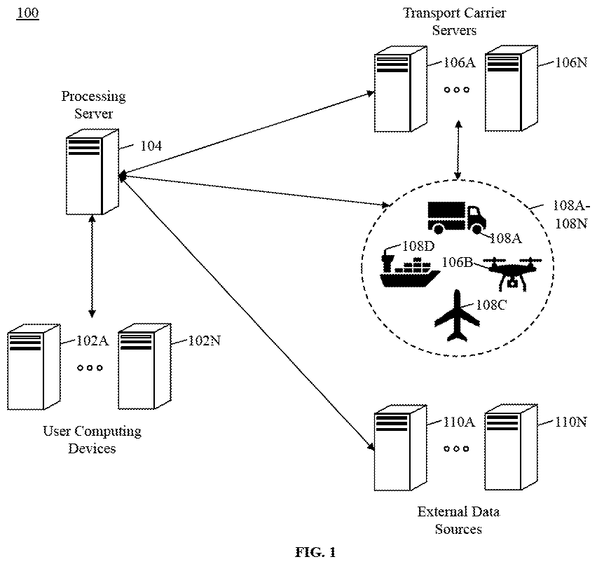

FIG. 1 illustrates a system 100 for autonomous orchestration of intermodal logistics transportation. The system 100 can include one or more user computing devices 102A-102N, a processing server 104, one or more transport carrier servers 106A-106N, one or more transport carrier vehicles 108A-108N, and one or more external data sources 110A-110N. The components of the system 100 are communicatively coupled to one another via one or more communication networks, such as the Internet, a local area network, a wide area network, a cellular communication network, a satellite network, or any combination thereof.

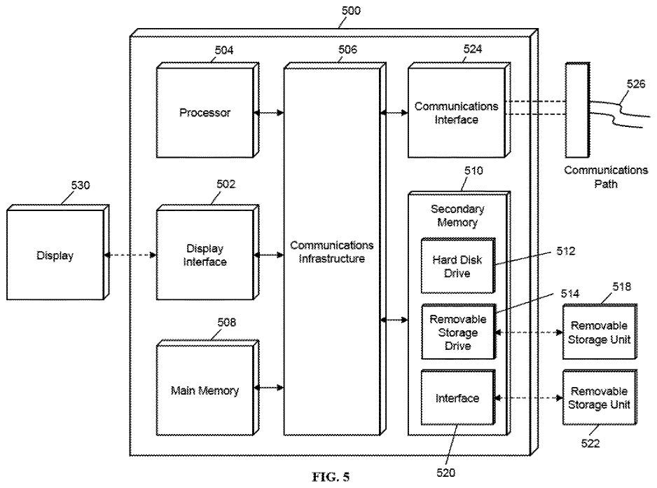

The user computing devices 102A-102N may be any computing device capable of storing, compiling, and organizing data and receiving and sending that data to and from other computing devices, such as the processing server 104, the transport carrier servers 106A-106N, and the external data sources 110A-110N, via one or more communication methods, such as radio frequency, local area networks, wireless area networks, cellular communication networks, Bluetooth, the Internet, etc. It can be appreciated that any number of user computing devices 102A, 102B . . . 102N can be a part of the system 100, including a single user computing device 102. In exemplary embodiments, the user computing devices 102A-102N are associated with users that initiate, manage, or receive shipments through the system 100. For example, the user computing devices 102A-102N may be operated by shippers that originate payload shipments, receivers that accept payload deliveries, brokers that coordinate logistics services between shippers and carriers, third-party logistics providers (3PLs) and fourth-party logistics providers (4PLs) that manage supply chain operations on behalf of shippers, and warehousing operators that manage storage and distribution facilities. Each user computing device 102A-102N may include at least one processor, a memory, a display device (e.g., a touchscreen, an LCD monitor, etc.), an input device (e.g., a keyboard, a pointing device, a touchscreen, etc.), and a communication interface configured to transmit and receive data over the one or more communication networks. The user computing devices 102A-102N may be in the form of a desktop computer, a laptop computer, a tablet computer, a mobile phone (e.g., a smartphone), or any other suitable computing device. The user computing devices 102A-102N are configured to access a user interface provided by the processing server 104, such as a web-based interface served via a web browser or a native mobile application, through which a user can enter and submit shipping orders including order data to the processing server 104. The user computing devices 102A-102N may be implemented in the computer system 500 illustrated in FIG. 5 using hardware, software executed on hardware, firmware, non-transitory computer readable media having instructions stored thereon, or a combination thereof and may be implemented in one or more computer systems or other processing systems.

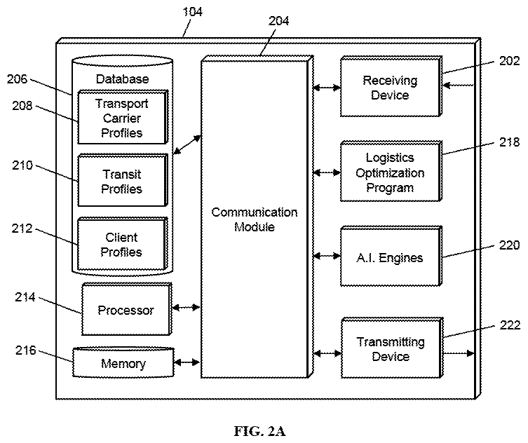

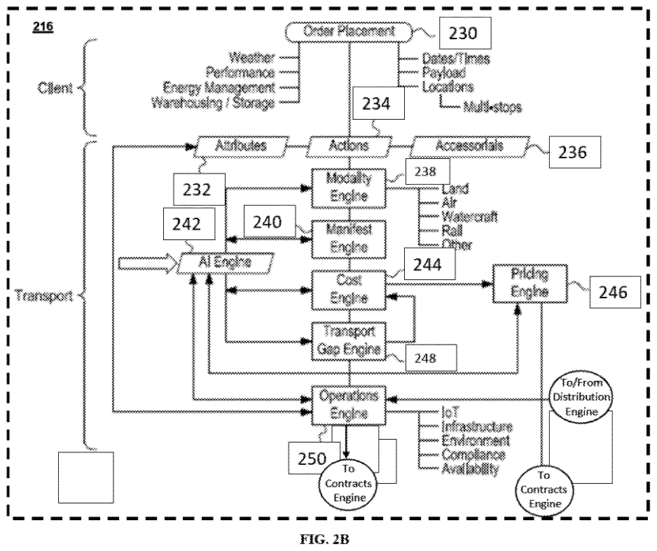

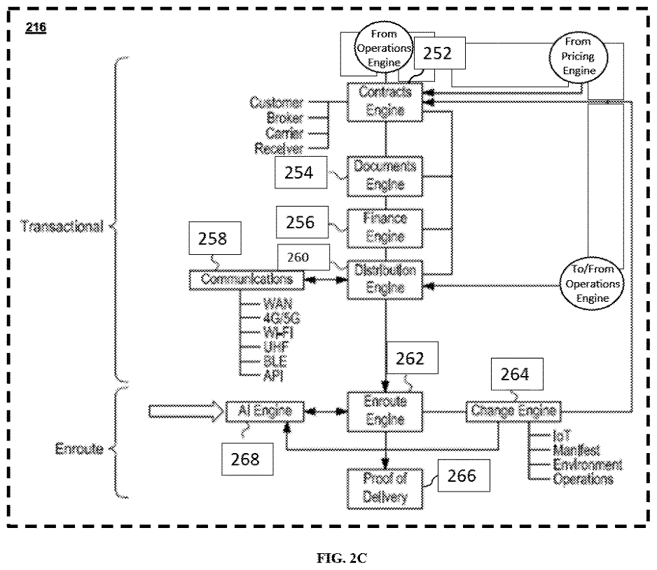

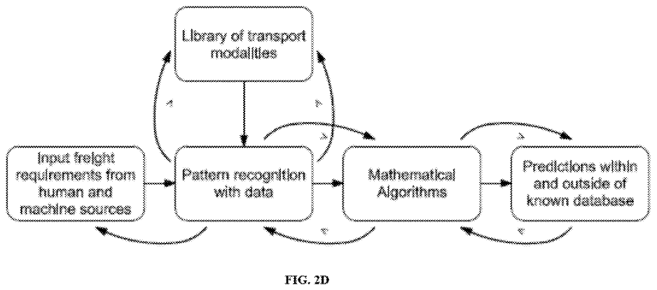

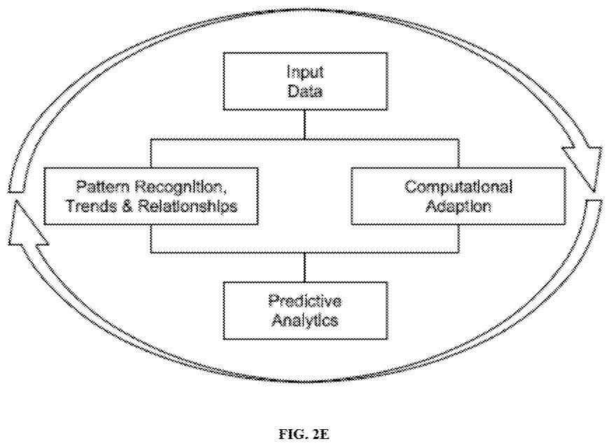

The processing server 104 may be any server computer or cluster of server computers capable of receiving, storing, processing, and transmitting data to and from other computing devices, such as the user computing devices 102A-102N, the transport carrier servers 106A-106N, the transport carrier vehicles 108A-108N, and the external data sources 110A-110N, via one or more communication methods, such as radio frequency, local area networks, wireless area networks, cellular communication networks, Bluetooth, the Internet, etc. The processing server 104 comprises one or more processors and one or more non-transitory computer-readable storage media storing instructions that, when executed by the one or more processors, cause the processing server 104 to perform the autonomous logistics orchestration functions described herein. The processing server 104 is the central computational component of the system 100 and is operated by a logistics orchestration platform provider. The processing server 104 is configured to host and execute a plurality of software engines including at least an attributes engine, a modality engine, a manifest engine, a first Artificial Intelligence (AI) Engine, a Transport Gap Engine, a Cost Engine, a Pricing Engine, an Operations Engine, a Contracts Engine, a Documents Engine, a Finance Engine, a Distribution Engine, an Enroute Engine, a Change Engine, and a second AI Engine, each of which is described in further detail below with reference to FIGS. 2A-2E. The processing server 104 is communicatively coupled to one or more databases configured to store shipping orders, transit profiles, trained AI models, optimized logistics solutions, carrier modality libraries, contract records, financial transaction records, manifest data, historical logistics datasets, and other data necessary for the functions described herein. The processing server 104 is further configured to serve a user interface to the user computing devices 102A-102N over the one or more communication networks, through which users can submit shipping orders, view optimized logistics solutions, receive alert notifications, and manage shipment status. The processing server 104 may be implemented in the computer system 500 illustrated in FIG. 5 using hardware, software executed on hardware, firmware, non-transitory computer readable media having instructions stored thereon, or a combination thereof and may be implemented in one or more computer systems or other processing systems.

The transport carrier servers 106A-106N may be any server computer or cluster of server computers capable of receiving, storing, processing, and transmitting data to and from other computing devices, such as the processing server 104, the user computing devices 102A-102N, and the transport carrier vehicles 108A-108N, via one or more communication methods, such as radio frequency, local area networks, wireless area networks, cellular communication networks, Bluetooth, the Internet, etc. It can be appreciated that any number of transport carrier servers 106A, 106B . . . 106N can be a part of the system 100, including a single transport carrier server 106. In exemplary embodiments, each transport carrier server 106A-106N is associated with and operated by a transport carrier entity that owns, leases, or operates a fleet of transport carrier vehicles 108A-108N. Transport carrier entities may include, for example, truckload (TL) and less-than-truckload (LTL) freight carriers, rail operators, airline cargo operators, maritime shipping companies, drone fleet operators, ride share companies, bus companies, FAA Part 135 flight operators, and other entities that provide transportation services across one or more transport carrier modalities. Each transport carrier server 106A-106N may include at least one processor, a memory, a communication interface, and one or more databases storing carrier-specific data including vehicle fleet inventories, vehicle physical and performance characteristics (e.g., weight capacity, volume capacity, range, energy type, speed), operator availability and hours-of-service records, rate schedules, compliance certifications, insurance records, carrier performance data, compliance vetting data, and historical operational data. The transport carrier servers 106A-106N are configured to receive electronic dispatch instructions, optimized logistics solutions, maximum capacity loading manifests, revised manifests, and updated contract documents from the processing server 104, and to transmit carrier fleet data, rate confirmations, contract acceptances, and operational status updates to the processing server 104. The transport carrier servers 106A-106N may be implemented in the computer system 500 illustrated in FIG. 5 using hardware, software executed on hardware, firmware, non-transitory computer readable media having instructions stored thereon, or a combination thereof and may be implemented in one or more computer systems or other processing systems.

The transport carrier vehicles 108A-108N may be any vehicles (human or non-human) capable of transporting a payload and equipped with electronic control systems and IoT devices that enable communication with the processing server 104 and/or the transport carrier servers 106A-106N. It can be appreciated that any number of transport carrier vehicles 108A, 108B . . . 108N can be a part of the system 100, including a single transport carrier vehicle 108. In exemplary embodiments, the transport carrier vehicles 108A-108N comprise a mixture of traditional and transformative electric and sustainable vehicles spanning a plurality of transport carrier modalities including land vehicles (e.g., diesel trucks, electric trucks, electric vans, rail cars, bikes, etc.), aircraft (e.g., cargo planes, unmanned aerial vehicles, electric vertical takeoff and landing vehicles, etc.), watercraft (e.g., cargo ships, barges, autonomous surface vessels, etc.), human couriers, and other vehicle types (e.g., off-road vehicles, human-powered craft, autonomous vehicles, etc.) . Each transport carrier vehicle 108A-108N is associated with and operated by or on behalf of a transport carrier entity that operates a corresponding transport carrier server 106A-106N. Each transport carrier vehicle 108A-108N includes at least an Electronic Control Unit (ECU) or Powertrain Control Module (PCM) that provides real-time control of vehicle movement, sensor management, navigation, and health monitoring of onboard systems. Each transport carrier vehicle 108A-108N further includes one or more Internet of Things (IoT) devices physically interfaced with the ECU or PCM via one or more hardware sensor buses. The one or more IoT devices comprise an onboard processor, a multi-band full-duplex transceiver, and analog and digital input/output interfaces electrically connected to the ECU or PCM via the one or more hardware sensor buses. The one or more hardware sensor buses may operate using at least one vehicle communication protocol selected from the group consisting of CANbus, Modbus, MQTT, LoRaWAN, Bluetooth Low Energy (BLE), Wi-Fi, and Zigbee/Z-Wave. The one or more IoT devices are configured to read electronic signals from the one or more hardware sensor buses to obtain real-time operational data comprising at least one of vehicle diagnostic data, vehicle status data, vehicle mechanical data, vehicle operation data, operator control inputs, positional data (e.g., GPS coordinates), incipient failure signals, and environmental sensor data. The one or more IoT devices are further configured to process the obtained real-time operational data at an edge processing layer via the onboard processor to perform data fusion and filtering within dynamic operational constraints, and to transmit the processed real-time operational data to the processing server 104 via at least one wide-area communication band selected from the group consisting of EHF, UHF ISM band, cellular (e.g., 4G/5G), and satellite frequency bands. In embodiments, the one or more IoT devices further incorporate one or more AI models stored in a local memory of the onboard processor and executed by the onboard processor at the edge processing layer. The one or more AI models of the IoT devices can be created and trained by the processing server 104 and/or the transport carrier servers 106A-106N and transmitted to the one or more IoT devices over the communication network for local storage and execution, or can be commercially available AI models deployed to the one or more IoT devices. The one or more AI models of the IoT devices are configured to analyze the captured real-time operational data locally on the onboard processor, including performing pattern recognition, anomaly detection, incipient failure prediction, and data classification on the raw sensor data obtained from the one or more hardware sensor buses prior to transmission to the processing server 104. The one or more IoT devices relay the analyzed data, including raw or filtered sensor data together with inference outputs generated by the one or more AI models (e.g., anomaly classifications, failure probability scores, and predictive maintenance indicators), to the processing server 104 and/or the transport carrier servers 106A-106N via the at least one wide-area communication band. By performing AI-based analysis at the edge processing layer of the one or more IoT devices, the system 100 reduces data transmission bandwidth and latency between the transport carrier vehicles 108A-108N and the processing server 104, enables faster detection and preliminary classification of logistics gap conditions at the vehicle level, and provides the processing server 104 and/or the transport carrier servers 106A-106N with pre-analyzed data that accelerates downstream processing by the AI Engines 220. The one or more IoT devices are further configured to receive electronic control signals from the processing server 104, including corrective routing actions and closed-loop feedback control instructions, and to write the received control signals to the ECU or PCM of the transport carrier vehicle via the one or more hardware sensor buses, thereby enabling autonomous vehicle operations including Beyond Visual Line of Sight (BVLOS) capabilities. Where authorized, the one or more IoT devices deliver closed-loop feedback control to connected vehicle systems, enabling autonomous operations. Operating in concert with the processing server 104, the transport carrier vehicles 108A-108N and their associated IoT devices form a fully connected system of systems across the end-to-end supply chain. In addition to the IoT devices installed on, or otherwise associated with, the transport carrier vehicles 108A-108N, the system 100 can further integrate with mobile and stationary freight handling systems and passenger handling systems across the supply chain, including IoT-enabled loading docks, warehouse conveyor systems, container handling equipment, and other freight infrastructure devices. These freight and/or passenger handling systems can be interfaced with the processing server 104 via the one or more communication networks to provide real-time data regarding freight and/or passenger handling status, loading and unloading progress, and transloading operations, enabling the processing server 104 to coordinate freight and/or passenger handling activities in concert with transport vehicle operations. This architecture enables continuous coordination of multiple, concurrent load tenders across diverse transport assets, while accounting for human constraints, scheduling requirements, and cost optimization. The result is true Just-in-Time execution—minimizing delays, transloading inefficiencies, idle time, and Hours-of-Service inefficiencies—while maximizing asset utilization and aligning operations with predictive demand signals generated by the AI Engines 220.

The external data sources 110A-110N may be any computing devices, server computers, databases, data feeds, or application programming interfaces (APIs) capable of providing data to the processing server 104 via the one or more communication networks. It can be appreciated that any number of external data sources 110A, 110B . . . 110N can be a part of the system 100, including a single external data source 110. In exemplary embodiments, the external data sources 110A-110N provide real-time and historical data from a plurality of heterogeneous data domains relevant to logistics orchestration. The external data sources 110A-110N may include, for example, traffic monitoring systems that provide real-time and predicted traffic pattern data; weather data services that provide current conditions, forecasts, and severe weather alerts; geospatial databases that provide infrastructure availability data, road network topology, navigable waterway data, airspace restriction data, and geographic constraint data; regulatory compliance databases that provide hours-of-service regulations, hazardous material transportation rules, customs and border requirements, and jurisdictional permit requirements; vehicle telematics systems that provide fleet-wide diagnostic and performance data; load board systems that provide available load tenders from shippers and brokers; fuel and energy pricing systems that provide current and projected fuel surcharge and energy cost data; and financial processing networks that facilitate Electronic Data Interchange (EDI) and Automated Clearing House (ACH) transactions. The external data sources 110A-110N are configured to transmit data to the processing server 104 via one or more APIs, data feeds, or other electronic data exchange mechanisms over the one or more communication networks. The processing server 104 ingests data from the external data sources 110A-110N for use by the trained AI model, the first AI Engine, the second AI Engine, the Cost Engine, the Pricing Engine, the Operations Engine, and other engines of the processing server 104 in generating and dynamically updating optimized logistics solutions, transit profiles, corrective routing actions, and other outputs described herein.

### Processing Server

FIG. 2A illustrates an embodiment of the processing server 104 of the system 100 of FIG. 1. It will be apparent to persons having skill in the relevant art that the embodiment of the processing server 104 illustrated in FIG. 2A is provided as illustration only and is not exhaustive of all possible configurations of the processing server 104 suitable for performing the functions as discussed herein. For example, the computer system 500 illustrated in FIG. 5 and discussed in more detail below can be a suitable configuration of the processing server 104.

The processing server 104 can include a receiving device 202. The receiving device 202 can be configured to receive data over one or more communication networks via one or more network protocols. In some instances, the receiving device 202 can be configured to receive data from the user computing devices 102A-102N, the transport carrier servers 106A-106N, the transport carrier vehicles 108A-108N, the external data sources 110A-110N, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processor 214 to carry out the methods and systems described herein.

The receiving device 202 can be configured to receive data signals electronically transmitted by the user computing devices 102A-102N that are superimposed or otherwise encoded with shipping orders including order data, such as payload specifications, shipment scheduling data, payload origin data, payload destination data, and payload shipment preference data. The receiving device 202 can also be configured to receive data signals electronically transmitted by the transport carrier servers 106A-106N that are superimposed or otherwise encoded with carrier fleet data including vehicle fleet inventories, vehicle physical and performance characteristics, operator availability and hours-of-service records, rate schedules, compliance certifications, rate confirmations, contract acceptances, and operational status updates. The receiving device 202 can also be configured to receive data signals electronically transmitted by the transport carrier vehicles 108A-108N, including real-time operational data transmitted by one or more IoT devices physically interfaced with an Electronic Control Unit (ECU) or Powertrain Control Module (PCM) of the transport carrier vehicles 108A-108N, the real-time operational data comprising at least one of vehicle diagnostic data, vehicle status data, vehicle mechanical data, vehicle operation data, operator control inputs, positional data, incipient failure signals, environmental sensor data, and confirmation data indicating execution of corrective routing actions. The receiving device 202 can also be configured to receive data signals electronically transmitted by the external data sources 110A-110N that are superimposed or otherwise encoded with real-time and historical data including traffic pattern data, weather data, geospatial and infrastructure data, regulatory compliance data, vehicle telematics data, available load tenders, fuel and energy pricing data, and financial transaction data.

The processing server 104 can also include a communication module 204. The communication module 204 can be configured to transmit data between modules, engines, databases, memories, and other components of the processing server 104 for use in performing the functions discussed herein. The communication module 204 can be comprised of one or more communication types and utilize various communication methods for communications within the processing server 104. For example, the communication module 204 can be comprised of a bus, contact pin connectors, wires, etc. In some embodiments, the communication module 204 can also be configured to communicate between internal components of the processing server 104 and external components of the processing server 104, such as externally connected databases, display devices, input devices, etc. The communication module 204 facilitates data exchange between the receiving device 202, the database 206, the processor 214, the memory 216, the logistics optimization program 218, the AI Engines 220, and the transmitting device 222, enabling the sequential and parallel processing flows described herein.

The processing server 104 can also include a database 206. The database 206 can be configured to store data for use by the processing server 104 in performing the autonomous logistics orchestration functions discussed herein. The database 206 can be any suitable type of database, such as a relational database, a structured query language (SQL) database, a distributed database, an object database, a NoSQL database, or any combination thereof. The database 206 can be stored on one or more non-transitory computer-readable storage media communicatively coupled to the processor 214. In some embodiments, the database 206 may be comprised of multiple databases, such as different databases for storing different categories of data.

The database 206 can include transport carrier profiles 208. The transport carrier profiles 208 comprise data records for each transport carrier entity associated with the transport carrier servers 106A-106N and transport carrier vehicles 108A-108N registered in the system 100. Each transport carrier profile 208 can include a carrier modality library detailing physical, operational, and performance characteristics of transport carrier vehicles 108A-108N associated with the transport carrier entity, including at least vehicle type, transport carrier modality classification (e.g., land, air, water, rail, other), energy type (e.g., battery, fossil fuel, fuel cell, sustainable aviation fuel), payload weight capacity, payload volume capacity, payload dimensional constraints, operational range, speed characteristics, and environmental operating requirements. Each transport carrier profile 208 can further include operator data such as operator availability, hours-of-service records, licensing and certification data, and compliance records. Each transport carrier profile 208 can further include commercial data such as rate schedules for truckload (TL) and less-than-truckload (LTL) shipments, accessorial rate schedules, fee structures, contract term thresholds, payment arrangement preferences, insurance records, and historical operational performance data. The transport carrier profiles 208 serve as the carrier modality database queried by the modality engine and the first AI Engine in determining recommended transport carrier modalities and generating proximity matrix data structures, as described in further detail below with reference to FIGS. 2B-2C.

The database 206 can further include transit profiles 210. The transit profiles 210 comprise data records for each transit profile generated by the manifest engine of the logistics optimization program 218. Each transit profile 210 can include at least a payload origin, a payload destination, one or more intermediate stops, and for each leg of the route, an assigned transport carrier modality, an assigned transport carrier vehicle, estimated transit times, operator hours-of-service constraints, energy management parameters, infrastructure requirements, and environmental requirements. The transit profiles 210 can further include associated shipping order data, optimized logistics solution data including transport carrier assignments, routing instructions, and scheduling parameters, maximum capacity loading manifests, revised manifests generated in response to corrective routing actions, and intermodal transfer solutions generated in response to identified transport gaps. The transit profiles 210 are dynamically updated during transit execution in response to corrective routing actions generated by the Change Engine and the second AI Engine, as described in further detail below.

The database 206 can further include client profiles 212. The client profiles 212 comprise data records for each user, entity, or party registered to access the system 100 via the user computing devices 102A-102N, the transport carrier servers 106A-106N, or other authorized devices. Each client profile 212 can include authentication credentials (e.g., usernames, hashed passwords, multi-factor authentication tokens, API keys), role assignments identifying the party's function within the logistics supply chain (e.g., shipper, passenger, broker, warehouser, carrier, receiver, third-party logistics provider, fourth-party logistics provider), and access control policies defining rights-based permissions for one or more functions of the system 100. The access control policies stored in each client profile 212 are enforced by a secure administration object-oriented interface of the processing server 104 such that each party is provided with platform features commensurate with their individual tasks associated with logistics transportation. For example, the client profiles 212 can be configured such that shippers and receivers are provided access to booking, shipment management, and payment functions; brokers are provided access to carrier modality fleet configuration, rate estimation for LTL and TL shipments including all accessorials (anything that goes beyond the basics of dock-to-dock transportation), contract agreement management, fee structure configuration, document management, payment management, messaging, enroute management, customer support, compliance management, and business intelligence reporting functions; and carriers are provided access to posted booking and load identification, rate estimation, contract term threshold configuration, payment arrangement management, notification management, and operator and vehicle compliance functions. Each client profile 212 can further include party-specific preferences such as preferred transport carrier modalities, cost constraints, service level requirements, notification preferences, and default origin and destination addresses. The client profiles 212 are queried by the logistics optimization program 218 during order processing, contract generation, document distribution, and financial transaction execution to verify authorization and enforce role-based access control, as described in further detail below with reference to FIGS. 2B-2C.

The client profiles 212 can further store shipping orders received from the user computing devices 102A-102N, trained AI models used by the AI Engines 220, historical logistics datasets used for training and retraining of the trained AI models, influence-variable matrices generated by the AI Engines 220, contract records generated by the Contracts Engine, electronic contract documents generated by the Documents Engine, financial transaction records generated by the Finance Engine, manifest distribution records generated by the Distribution Engine, and resulting operational data collected during execution of optimized logistics solutions and fed back into the trained AI models via the computational feedback loop.

The processing server 104 can also include a processor 214. The processor 214 can be configured to perform the functions of the processing server 104 discussed herein as will be apparent to persons having skill in the relevant art. The processor 214 can be a single processor, a plurality of processors, or combinations thereof. Processor 214 can have one or more processor “cores.” The processor 214 can be a special purpose or a general-purpose processor device specifically configured to perform the functions discussed herein, including executing the logistics optimization program 218 and the AI Engines 220. In some embodiments, the processor 214 can include and/or be comprised of a plurality of engines and/or modules specially configured to perform one or more functions of the processing server 104, such as the engines of the logistics optimization program 218 and the AI Engines 220 described in further detail below with reference to FIGS. 2B-2E. As used herein, the term “module” can be software or hardware particularly programmed to receive an input, perform one or more processes using the input, and provide an output. The input, output, and processes performed by various modules will be apparent to one skilled in the art based upon the present disclosure. As used herein, the term “engine” refers to a type of module comprising software, hardware, or a combination thereof that is particularly programmed to receive a defined input from a preceding engine or data source, perform one or more specialized processes using the input, and provide a defined output to a succeeding engine or data store within a sequential process chain, wherein each engine exposes input/output (I/O) interfaces configured to interoperate with connecting engines within the process chain. Processors suitable for the execution of the logistics optimization program 218 and the AI Engines 220 include, by way of example, both general and special purpose microprocessors, graphics processing units (GPUs), tensor processing units (TPUs), field programmable gate arrays (FPGAs), application specific integrated circuits (ASICs), and any one or more processors of any kind of digital computer. Generally, the processor 214 will receive instructions and data from the memory 216 and/or the database 206.

The processing server 104 can also include a memory 216. The memory 216 can be configured to store data for use by the processing server 104 in performing the functions discussed herein, such as program code, encryption keys and algorithms, communication protocols and standards, data formatting standards and protocols, and other data that can be suitable for use by the processing server 104 in the performance of the functions disclosed herein as will be apparent to persons having skill in the relevant art. The memory 216 can be any suitable type of memory, such as read-only memory (ROM), random access memory (RAM), flash memory, etc. In some embodiments, the memory 216 can be comprised of or can otherwise include a relational database that utilizes structured query language for the storage, identification, modifying, updating, accessing, etc. of structured data sets stored therein. The memory 216 can be configured to store, for example, program code for the logistics optimization program 218 and the AI Engines 220, trained AI model parameters and weights, cryptographic keys and algorithms, communication protocols and standards, API endpoint configurations for the external data sources 110A-110N, data formatting rules, network identifiers, user authentication credentials, session data, and temporary processing data generated during execution of the logistics optimization program 218 and the AI Engines 220. The memory 216 can be distinct from the database 206 or can be a portion of the same non-transitory computer-readable storage media, as will be apparent to persons having skill in the relevant art.

The processing server 104 can also include a logistics optimization program 218. The logistics optimization program 218 can be a software program stored in the memory 216 and/or the database 206 and executed by the processor 214. The logistics optimization program 218 comprises a plurality of software engines that are executed sequentially and in concert with the AI Engines 220 to perform the autonomous logistics orchestration functions described herein. The logistics optimization program 218 includes at least an attributes engine, a modality engine, a manifest engine, a Transport Gap Engine, a Cost Engine, a Pricing Engine, an Operations Engine, a Contracts Engine, a Documents Engine, a Finance Engine, a Distribution Engine, an Enroute Engine, and a Change Engine. Each engine within the logistics optimization program 218 can be independently developed, but the engines are executed sequentially with data passing between engines in a process chain, and each engine requires the necessary input/output (I/O) to interface with a connecting engine within the process chain. The engines of the logistics optimization program 218 interface with the AI Engines 220 to obtain analytical and numerical processing necessary to converge on either exact or optimized solutions. The logistics optimization program 218 is described in further detail below with reference to FIGS. 2B-2C.

The processing server 104 can also include one or more AI Engines 220. The AI Engines 220 comprise at least a first AI Engine and a second AI Engine, each implemented as software modules stored in the memory 216 and/or the database 206 and executed by the processor 214. In some embodiments, the AI Engines 220 may be executed on specialized hardware of the processor 214, such as GPUs, TPUs, FPGAs, or ASICs, to accelerate the mathematical and predictive analytics computations described herein. The first AI Engine is configured to process transit profiles generated by the manifest engine with corresponding real-time data by inputting the data into a trained AI model and outputting optimized payload transport solutions for each recommended transport carrier modality. The second AI Engine is configured to decompose real-time operational data received from the transport carrier vehicles 108A-108N into influence-variable matrices, identify logistics gap conditions by pattern recognition, and generate corrective routing actions during transit. The AI Engines 220 serve as the analytical core of the orchestration process, performing four overall functions: (1) accepting input data from the engines of the logistics optimization program 218 and from the external data sources 110A-110N; (2) examining the input data for pattern recognition, trends, and relationships; (3) adapting the data into appropriate equations and models; and (4) providing predictive analytics. The AI Engines 220 further implement a computational feedback loop that feeds resulting operational data from executed logistics solutions back into the trained AI model for retraining, thereby continuously improving predictive accuracy. The AI Engines 220, including their core processing components and computational feedback loop, are described in further detail below with reference to FIGS. 2D-2E.

The processing server 104 can also include a transmitting device 222. The transmitting device 222 can be configured to transmit data over one or more communication networks via one or more network protocols. In some instances, the transmitting device 222 can be configured to transmit data to the user computing devices 102A-102N, the transport carrier servers 106A-106N, the transport carrier vehicles 108A-108N, and other entities via one or more communication methods, such as local area networks, wireless area networks, cellular communication networks, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to the user computing devices 102A-102N that are superimposed or otherwise encoded with optimized logistics solutions, transit profile data, shipment status updates, alert notifications regarding corrective routing actions, revised manifests, estimated completion schedules, and proof of delivery confirmations. The transmitting device 222 can be configured to electronically transmit data signals to the transport carrier servers 106A-106N that are superimposed or otherwise encoded with electronic dispatch instructions, optimized logistics solutions, maximum capacity loading manifests, revised manifests, updated contract documents for electronic signature, financial transaction instructions, and alert notifications. The transmitting device 222 can be configured to electronically transmit data signals to the transport carrier vehicles 108A-108N that are superimposed or otherwise encoded with corrective routing actions transmitted as electronic control signals, closed-loop feedback control instructions, re-routing instructions, modality substitution recommendations, and load manifest revisions. In embodiments, the transmitting device 222 transmits corrective routing actions to the one or more IoT devices of the transport carrier vehicles 108A-108N via at least one communication channel selected from the group consisting of a wide area network (WAN), a 4G/5G cellular network, Wi-Fi, UHF, and Bluetooth Low Energy, enabling the one or more IoT devices to write the received control signals to the ECU or PCM of the transport carrier vehicle via one or more hardware sensor buses.

### Logistics Optimization Program

FIGS. 2B-2C are block diagrams illustrating the logistics optimization program 218 executed by the processing server 104 of the system 100 of FIG. 1. The logistics optimization program 218 comprises a plurality of software engines organized across a Transport Layer, a Transactional Layer, and an Enroute Layer, each layer having one or more engines configured to assist in autonomous logistics orchestration. The engines of the logistics optimization program 218 are executed sequentially with a feedback loop, and each engine provides interim calculations that interface with a family of diverse engines within and across the layers. Each engine within the logistics optimization program 218 can be independently developed, but the engines must be executed sequentially with the necessary input/output (I/O) to interface with a connecting engine within the process chain. All engines within the Transport Layer eventually pass through the AI Engines 220 (FIGS. 2D-2E) that provide analytical and numerical processing necessary to converge on either exact or optimized solutions. The effectiveness of the AI Engines 220 influences the outcome of the results; thus, a low fidelity system may not yield a fully autonomous solution. In embodiments, the trained AI models used by the AI Engines 220 can be created and trained by the processing server 104 using historical logistics datasets stored in the database 206 and computational resources of the processor 214 (e.g., GPUs, TPUs, or other accelerators). Alternatively, or in combination, the trained AI models can be commercially available AI models hosted by third-party providers and accessed by the processing server 104 via one or more APIs over the communication network. Where the AI Engines 220 utilize commercially available AI models, the inputs to the AI Engines 220 described herein, including transit profiles, influence-variable matrices, real-time data, and other operational parameters, can be formatted and submitted as Retrieval-Augmented Generation (RAG) prompts to the commercially available AI models. In such embodiments, the processing server 104 retrieves relevant context data from the database 206, including historical logistics datasets, transport carrier profiles 208, and prior optimized logistics solutions, and assembles the retrieved context data together with the current input data into structured RAG prompts that are transmitted to the commercially available AI model via the one or more APIs. The commercially available AI model processes the RAG prompts and returns output data, such as optimized payload transport solutions, corrective routing actions, or predictive analytics, which the processing server 104 receives and integrates into the logistics optimization program 218 for further processing by downstream engines. In embodiments, the processing server 104 may use a hybrid approach in which certain AI Engine functions are performed by locally trained AI models created and retrained by the processing server 104 while other AI Engine functions are performed by commercially available AI models accessed via RAG prompts, the selection between locally trained and commercially available AI models being configurable based on computational resource availability, latency requirements, and prediction accuracy thresholds stored in the database 206. The following description traces a complete use case flow through the system 100, from client order placement through proof of delivery. To further illustrate the operation of each engine, a real-world shipping order example is described throughout the following use case flow. In this example, a shipper located in Philadelphia, Pennsylvania, United States submits a shipping order to transport a payload of 12 pallets of pharmaceutical products, the pallets having a combined weight of approximately 18,000 pounds and requiring temperature-controlled transport between 2° C. and 8° C., from a warehouse facility at the payload origin in Philadelphia, Pennsylvania to a distribution center at the payload destination in Los Angeles, California, with a required delivery window of five calendar days from the date of the shipping order. The shipper specifies a cost constraint of no more than $8,500 for the total shipment and a preference for sustainable or electric vehicle modalities where available.

### Order Placement

The logistics optimization program 218 begins with an Order Placement module 230. The Order Placement module 230 corresponds to the user interface served by the processing server 104 to the user computing devices 102A-102N over the one or more communication networks. Through the Order Placement module 230, a user (e.g., a shipper, a passenger, a broker, a 3PL, or a 4PL) operating a user computing device 102A submits a shipping order to the processing server 104. The shipping order includes order data for a payload (e.g., one or more people and/or one or more goods) that can include, for example, user identification data (e.g., user name, user location, user contact information, unique client identifier, etc.) a payload specification for a payload (e.g., weight, dimensions, volume, commodity type, hazardous material classification), shipment scheduling data (e.g., one or more dates, one or more times, pickup and delivery time windows), payload origin data and payload destination data (e.g., single stop or multi-stop locations, addresses, geocoordinates), and/or payload shipment preference data (e.g., carrier preferences, modality preferences, cost constraints, service level requirements). In embodiments, the Order Placement module 230 does not require any specific order of data input, but does require that all client requirements are entered before proceeding to the Transport Layer. The receiving device 202 of the processing server 104 receives the shipping order from the user computing device 102A and stores the shipping order in the database 206, e.g., in a client profile 212 associated with the user of the user computing device 102A. The processor 214 queries the client profiles 212 stored in the database 206 to verify the identity and authorization of the submitting user and to retrieve any party-specific preferences associated with the client profile 212 of the submitting user. Upon verification, the order data is passed to the Transport Layer for further processing.

In the real-world shipping order example, the shipper in Philadelphia accesses the user interface of the Order Placement module 230 via a web browser on the user computing device 102A and enters the following order data: a payload specification identifying 12 pallets of pharmaceutical products with a combined weight of 18,000 pounds, dimensions of 48 inches×40 inches×60 inches per pallet, a commodity type of “pharmaceutical—cold chain,” and a temperature range of 2° C. to 8° C.; shipment scheduling data specifying a pickup date of the current business day and a delivery deadline of five calendar days from pickup; payload origin data identifying the warehouse facility address and geocoordinates in Philadelphia, Pennsylvania; payload destination data identifying the distribution center address and geocoordinates in Los Angeles, California; and payload shipment preference data specifying a maximum total cost of $8,500 and a preference for sustainable or electric vehicle modalities. The processing server 104 receives this shipping order via the receiving device 202, stores the shipping order in the database 206 in the client profile 212 associated with the shipper, verifies the shipper's identity and authorization, and passes the order data to the Transport Layer.

### Transport Layer

The Transport Layer of the logistics optimization program 218 comprises a plurality of engines configured to process the order data from the Order Placement module 230 and generate an optimized logistics solution. The Transport Layer includes an Attributes Engine 232, an Actions Engine 234, an Accessorials Engine 236, a Modality Engine 238, a Manifest Engine 240, a Cost Engine 244, a Pricing Engine 246, a Transport Gap Engine 248, and an Operations Engine 250. The engines of the Transport Layer interface with a first AI Engine of the AI Engines 220, identified in FIG. 2B as AI Engine 242, to obtain analytical and numerical processing. Processing in the Transport Layer loops through the engines described below, resulting in a manifest with zero gaps, acceptable pricing, and that meets operations requirements.

The Attributes Engine 232 is configured to extract and classify the order data received from the Order Placement module 230. The Attributes Engine 232 parses the shipping order stored in the database 206 and extracts payload and transportation parameters including, but not limited to, payload weight, payload dimensions, payload volume, commodity type, hazardous material classifications, temperature and environmental sensitivity requirements, and special handling requirements. The Attributes Engine 232 further classifies the extracted parameters into categories corresponding to the physical, operational, and regulatory attributes that will influence downstream modality selection, manifest generation, and cost analysis. In embodiments, the Attributes Engine 232 receives supplemental attribute data from the external data sources 110A-110N, such as weather data, performance data, energy management data, and warehousing and storage data, and incorporates the supplemental attribute data into the extracted and classified order data. The classified output of the Attributes Engine 232 is passed to the Actions Engine 234.

In the real-world shipping order example, the Attributes Engine 232 receives the order data for the pharmaceutical shipment and extracts the following parameters: a payload weight of 18,000 pounds, pallet dimensions of 48×40×60 inches per pallet for 12 pallets, a total payload volume of approximately 800 cubic feet, a commodity type of “pharmaceutical—cold chain,” and a temperature sensitivity requirement of 2° C. to 8° C. The Attributes Engine 232 classifies these extracted parameters into the following categories: physical attributes (weight of 18,000 lbs., volume of 800 cu. ft., 12-pallet count), operational attributes (cold chain temperature control required, pharmaceutical handling protocols), and regulatory attributes (FDA cold chain compliance requirements, potential DEA documentation depending on specific pharmaceutical contents). The Attributes Engine 232 further receives supplemental attribute data from the external data sources 110A-110N, including a weather forecast indicating high temperatures exceeding 100° F. across the southwestern United States route corridor during the transit window, which the Attributes Engine 232 incorporates into the classified order data as an environmental sensitivity flag. The classified output of the Attributes Engine 232, comprising the extracted and categorized physical, operational, and regulatory attributes together with the environmental sensitivity flag, is passed to the Actions Engine 234.

The Actions Engine 234 is configured to receive the classified output of the Attributes Engine 232 and determine one or more required operational actions for fulfilling the shipping order. The operational actions can include, for example, pickup scheduling, loading and unloading sequences, transloading operations between modalities, customs and border clearance actions, and special handling procedures. The results of the Actions Engine 234 are passed to the Accessorials Engine 236 and to the Modality Engine 238.

In the real-world shipping order example, the Actions Engine 234 receives the classified output from the Attributes Engine 232 and determines the following required operational actions: a scheduled pickup at the Philadelphia warehouse facility requiring a refrigerated loading dock; a loading sequence specifying forklift loading of 12 pallets into a temperature-controlled trailer with continuous temperature monitoring activation upon loading; one or more potential transloading operations between modalities at intermediate transfer points (e.g., an intermodal rail yard in Chicago, Illinois) requiring temperature-controlled transloading bays to maintain the 2° C. to 8° C. cold chain during transfer; and special handling procedures requiring temperature data logger placement on each pallet and chain-of-custody documentation for pharmaceutical goods. The Actions Engine 234 passes these determined operational actions to the Accessorials Engine 236 and to the Modality Engine 238.

The Accessorials Engine 236 is configured to identify and classify accessorial services required or requested for the shipping order. Accessorial services can include, for example, liftgate service, inside delivery, residential delivery, detention and demurrage charges, hazardous material handling, temperature-controlled transport, signature-required delivery, redelivery, storage-in-transit, and other supplemental services known in the art. The Accessorials Engine 236 receives input from the Actions Engine 234 and from the shipping order data stored in the database 206, identifies applicable accessorials based on the payload specification and shipment preferences, and generates an accessorials data record that is associated with the shipping order in the database 206. The accessorials data record is passed to the Cost Engine 244 for cost calculation and to the Contracts Engine 252 for inclusion in contract terms.

In the real-world shipping order example, the Accessorials Engine 236 receives the operational actions from the Actions Engine 234 and the shipping order data from the database 206 and identifies the following applicable accessorial services: temperature-controlled transport (continuous refrigeration at 2° C. to 8° C. for the entire transit duration), temperature monitoring service (real-time IoT temperature data logger reporting), signature-required delivery (chain-of-custody signature at the Los Angeles distribution center), detention charges (potential detention at origin and destination facilities if loading or unloading exceeds standard free time), and pharmaceutical handling surcharge (specialized handling protocols for pharmaceutical cold chain goods). The Accessorials Engine 236 generates an accessorials data record listing these five identified accessorial services with their associated classification codes and stores the accessorials data record in the database 206 in association with the shipping order. The accessorials data record is passed to the Cost Engine 244 for cost calculation and to the Contracts Engine 252 for inclusion in contract terms.

The Modality Engine 238 is configured to receive the results of the Actions Engine 234 and determine one or more recommended transport carrier modalities for transporting the payload. In determining the one or more recommended transport carrier modalities, the Modality Engine 238 queries the transport carrier profiles 208 stored in the database 206 to retrieve the carrier modality library detailing physical, operational, and performance characteristics of available transport carrier vehicles 108A-108N. The Modality Engine 238 compares the payload specification extracted by the Attributes Engine 232 against the capabilities of each transport carrier vehicle and eliminates from transport consideration each transport carrier vehicle having a data record indicating incapability of supporting the payload specification based on at least one of weight, size, volume, or distance. The Modality Engine 238 further considers a plurality of attributes in determining the one or more recommended transport carrier modalities, including energy type (e.g., battery, fossil fuel, fuel cell, sustainable aviation fuel), speed, volume capacity, distance capability, weight capacity, available routes, and environmental operating requirements. In embodiments, the Modality Engine 238 evaluates transport carrier modalities across land vehicles, aircraft, watercraft, oceanic craft, off-road craft, rail, human-powered craft, and other transportation modalities known in the art. The Modality Engine 238 outputs a transportation type recommendation comprising one or more recommended transport carrier modalities, and the recommendation is passed to the Manifest Engine 240 for further processing.

In the real-world shipping order example, the Modality Engine 238 receives the operational actions from the Actions Engine 234 and queries the transport carrier profiles 208 in the database 206. The Modality Engine 238 compares the payload specification (18,000 lbs., 800 cu. ft., 12 pallets, cold chain 2° C.-8° C., Philadelphia to Los Angeles, five-day delivery window) against the capabilities of available transport carrier vehicles 108A-108N. The Modality Engine 238 eliminates from transport consideration all transport carrier vehicles incapable of supporting the payload specification, including: all standard dry van trucks (lacking temperature-controlled capability), all electric vans with a range under 300 miles (insufficient distance capability for any single leg exceeding 300 miles), all drone and eVTOL aircraft (insufficient weight and volume capacity for 18,000 lbs. and 800 cu. ft.), and all watercraft (insufficient speed to meet the five-day delivery window for a transcontinental route). After elimination, the Modality Engine 238 evaluates the remaining eligible transport carrier vehicles across a plurality of attributes and outputs a transportation type recommendation comprising the following recommended transport carrier modalities: (1) a refrigerated diesel truck (truckload, direct route, fossil fuel), (2) a refrigerated intermodal combination of an electric refrigerated truck for the first and last legs combined with refrigerated rail for the long-haul middle leg (Philadelphia to Chicago by electric truck, Chicago to a rail terminal near Los Angeles by refrigerated rail car, rail terminal to Los Angeles distribution center by electric truck), and (3) a refrigerated cargo aircraft for the long-haul leg combined with electric refrigerated trucks for first-mile and last-mile legs. The transportation type recommendation comprising these three recommended transport carrier modalities is passed to the Manifest Engine 240.

The Manifest Engine 240 is configured to receive the transportation type recommendation from the Modality Engine 238 and generate a transit profile 210 for each recommended transport carrier modality. Each transit profile 210 includes, for example, the payload origin, the payload destination, one or more intermediate stops, and for each leg of the route, an assigned transport carrier modality. In generating each transit profile 210, the Manifest Engine 240 considers one or more factors including operator hours of service, physical limitations of the assigned transport carrier vehicle (e.g., range, fuel or energy capacity), energy management requirements (e.g., charging station availability for electric vehicles, fuel stop planning), environmental requirements (e.g., emissions restrictions, noise curfews, weather-related route constraints), and infrastructure requirements (e.g., bridge weight limits, tunnel height restrictions, port and terminal availability, runway length requirements, navigable waterway depth). The Manifest Engine 240 stores each generated transit profile 210 in the database 206. The generated transit profiles 210 are passed to the AI Engine 242 and to the Cost Engine 244 for further processing.

In the real-world shipping order example, the Manifest Engine 240 receives the three recommended transport carrier modalities from the Modality Engine 238 and generates a transit profile 210 for each. For the first recommended modality (refrigerated diesel truck, direct route), the Manifest Engine 240 generates a transit profile comprising: payload origin at the Philadelphia warehouse, intermediate stops at fuel and driver rest stops spaced to comply with FMCSA hours-of-service regulations (e.g., an intermediate stop in Columbus, Ohio after approximately 10 hours of driving and an intermediate stop in Amarillo, Texas after an operator mandatory rest period), and payload destination at the Los Angeles distribution center, with a single assigned transport carrier modality of refrigerated diesel truckload for all legs. For the second recommended modality (electric truck plus refrigerated rail), the Manifest Engine 240 generates a transit profile comprising: Leg 1 from the Philadelphia warehouse to an intermodal rail yard in Chicago, Illinois assigned to an electric refrigerated truck (approximately 760 miles, with one intermediate charging stop and one driver rest stop), Leg 2 from the Chicago intermodal rail yard to a rail terminal in San Bernardino, California assigned to a refrigerated rail car, and Leg 3 from the San Bernardino rail terminal to the Los Angeles distribution center assigned to an electric refrigerated truck (approximately 60 miles, no intermediate stop required). The Manifest Engine 240 considers charging station availability along the I-76/I-80 corridor for the electric truck legs, intermodal terminal scheduling availability at both rail yards, and a transit time estimate for the rail leg of approximately 72 hours. For the third recommended modality (air cargo plus electric trucks), the Manifest Engine 240 generates a transit profile comprising: Leg 1 from the Philadelphia warehouse to Philadelphia International Airport (PHL) cargo terminal assigned to an electric refrigerated truck, Leg 2 from PHL to Los Angeles International Airport (LAX) cargo terminal assigned to a refrigerated cargo aircraft, and Leg 3 from LAX cargo terminal to the Los Angeles distribution center assigned to an electric refrigerated truck. The Manifest Engine 240 stores all three generated transit profiles 210 in the database 206 and passes them to the AI Engine 242 and the Cost Engine 244.

The AI Engine 242 is the first AI Engine of the AI Engines 220 and serves as the analytical core of the Transport Layer. The AI Engine 242 interfaces with each engine of the Transport Layer to provide the analytical and numerical processing necessary to converge on either exact or optimized solutions. In embodiments, the AI Engine 242 comprises a trained AI model that is created and trained by the processing server 104 using historical logistics datasets, transit profile records, and resulting operational data stored in the database 206. In alternative embodiments, the AI Engine 242 utilizes a commercially available AI model accessed by the processing server 104 via one or more APIs over the communication network. Where the AI Engine 242 utilizes a commercially available AI model, the processing server 104 assembles the transit profiles, influence-variable matrices, real-time data, and other input parameters into RAG prompts by retrieving relevant context data from the database 206, including historical logistics datasets, transport carrier profiles 208, and prior optimized logistics solutions for similar shipping orders, and combining the retrieved context data with the current input data into structured prompts that are transmitted to the commercially available AI model. The commercially available AI model processes the RAG prompts and returns optimized payload transport solutions that the processing server 104 integrates into the logistics optimization program 218.

FIG. 2D is a block diagram illustrating the AI Engine core processing components shared by the AI Engine 242 and the AI Engine 268 (the second AI Engine, described below with reference to the Enroute Layer). The AI Engine core processing components comprise four overall processes. First, the AI Engine accepts input data, including input freight and/or passenger requirements from human and machine sources (e.g., the user computing devices 102A-102N, the transport carrier servers 104A-104N, the transport carrier vehicles 108A-108N, and the external data sources 110A-110N) and a library of transport modalities stored in the transport carrier profiles 208 of the database 206. Second, the AI Engine 242 and the AI Engine 268 examine the input data via pattern recognition with data, identifying trends and relationships among the influence variables. Third, the AI Engine 242 and the AI Engine 268 adapt the data into appropriate mathematical algorithms, converting all functions into a mathematical representation and assigning numerical relationships between event inputs and outputs. This approach enables the use of various data-driven models to establish mathematical functions that are learned from historical data and can extrapolate with minimum prediction errors. Dissecting numerous influence factors and variability into a series of smaller matrices enables solutions such as Singular Value Decomposition, Markov models, neural networks, and the like. The AI Engine 242 and the AI Engine 268 learn mathematical relationships between inputs (events) and outputs (numbers) using data-driven models. Part of its core is statistical learning combined with optimization at scale. The AI Engine 242 and the AI Engine 268 are built on top of the various mathematical algorithms and add boundary conditions, generative machine learning, adapting, and updating predictions to solve problems. Fourth, the AI Engine 242 and the AI Engine 268 provide predictions within and outside of a known database, outputting predictive analytics that inform the optimized payload transport solutions and corrective routing actions described herein. In embodiments where the AI Engine 242 and/or the AI Engine 268 utilize commercially available AI models, the four overall processes described above are performed by the commercially available AI model in response to RAG prompts assembled by the processing server 104. In such embodiments, the processing server 104 retrieves context data from the database 206, including historical logistics datasets and transport carrier profiles 208, and combines the retrieved context data with the current input data (e.g., transit profiles, real-time operational data, influence-variable matrices) into structured RAG prompts. The RAG prompts are transmitted to the commercially available AI model via one or more APIs, and the commercially available AI model performs the pattern recognition, mathematical algorithm adaptation, and predictive analytics processes in response to the RAG prompts and returns output data to the processing server 104.

Returning to the AI Engine 242 in the Transport Layer, upon receiving the transit profiles 210 from the Manifest Engine 240, the AI Engine 242 processes each transit profile 210 with corresponding real-time data for each recommended transport carrier modality. The real-time data includes, for example, transport carrier modality demographics, traffic patterns, and/or regulatory inputs obtained from the external data sources 110A-110N via the receiving device 202. The AI Engine 242 inputs the recommended transport carrier modalities with the corresponding real-time data into a trained AI model of the AI Engine 242. The trained AI model is configured to output an optimized payload transport solution for each recommended transport carrier modality. The AI Engine 242 generates a matrix of proximity distances and pathways between the payload origin and the payload destination of each individual load tender, starting from either a manual input or an arbitrary location, using at least latitude and longitude coordinates, zip or postcode data, relative bearing, and maritime navigation. The proximity matrix is bounded by infrastructure and geography constraints retrieved from one or more geospatial databases of the external data sources 110A-110N. The AI Engine 242 seeks the most efficient or cost-effective distribution considering all boundary conditions across all homogeneous and heterogeneous transit modalities, including risk to safety, schedule, and costs associated with transloading freight and/or passengers between various intermodal vehicles. The AI Engine 242 outputs an optimized payload transport solution for each recommended transport carrier modality, and the processing server 104 compares each optimized payload transport solution to the shing order to generate an optimized logistics solution comprising transport carrier assignments, routing instructions, and scheduling parameters.

In the real-world shipping order example, the AI Engine 242 receives the three transit profiles 210 from the Manifest Engine 240 and processes each with corresponding real-time data obtained from the external data sources 110A-110N, including: current traffic congestion data indicating heavy construction delays on Interstate 80 through central Pennsylvania, real-time FMCSA hours-of-service compliance data for available truck operators, current intermodal rail scheduling data indicating a 12-hour delay on westbound refrigerated rail departures from Chicago due to track maintenance, real-time ambient temperature data confirming forecasted high temperatures exceeding 100° F. along the I-40 corridor through Arizona, diesel fuel pricing data along the direct truck route averaging $4.15 per gallon, electricity pricing data at charging stations along the I-76/I-80 corridor, and current air cargo rate data and available cargo capacity at PHL. The AI Engine 242 generates a proximity matrix of distances and pathways between Philadelphia and Los Angeles bounded by infrastructure constraints (e.g., bridge weight limits on I-76, tunnel height restrictions, intermodal terminal locations, charging station locations, and airport cargo terminal capacities) and geography constraints (e.g., mountain pass elevation data for the I-70 and I-40 corridors). The AI Engine 242 inputs the three recommended transport carrier modalities with the corresponding real-time data into the trained AI model and outputs the following optimized payload transport solutions: for the first modality (direct refrigerated diesel truck), an optimized route via I-76 to I-70 to I-15 avoiding the I-80 construction delays, with estimated transit time of 4.2 days and estimated cost of $7,200; for the second modality (electric truck plus rail), an optimized solution reflecting the 12-hour rail delay from Chicago, with a revised estimated transit time of 4.8 days and estimated cost of $6,400 (with the electric truck legs utilizing the shipper's preferred sustainable modality); and for the third modality (air plus electric truck), an optimized solution with estimated transit time of 1.5 days and estimated cost of $14,800. The processing server 104 compares each optimized payload transport solution to the shipping order and generates an optimized logistics solution. The comparison reveals that the third modality (air) exceeds the shipper's $8,500 cost constraint and is therefore eliminated. The processing server 104 selects the second modality (electric truck plus refrigerated rail) as the optimized logistics solution because it satisfies the five-day delivery window (4.8 days), falls within the cost constraint ($6,400 of the $8,500 maximum), and aligns with the shipper's preference for sustainable vehicle modalities. The optimized logistics solution includes transport carrier assignments (Carrier A for the Philadelphia-to-Chicago electric truck leg, Rail Operator B for the Chicago-to-San Bernardino rail leg, and Carrier C for the San Bernardino-to-Los Angeles electric truck leg), routing instructions for each leg, and scheduling parameters including pickup time, intermediate transfer times at each intermodal terminal, and estimated delivery time.

In embodiments involving maximum capacity loading, the AI Engine 242 receives a plurality of load tenders from the processing server 104, each load tender received via the receiving device 202 from one or more shipper devices (e.g., the user computing devices 102A-102N) and one or more load board systems over the communication network. Each load tender comprises a load type such as pick only, pick and drop, or drop only, and associated accessorials and delivery requirements. The AI Engine 242 uniquely analyzes each individual load type first, then subsequently analyzes the combination of preceding and following loads. This process is daisy-chained to each proximity load to determine load hierarchy within the load vehicle. The AI Engine 242 sequentially inputs each load tender and one or more preceding load tenders into the trained AI model, which evaluates compatibility of each sequential load tender against boundary conditions including at least payload weight, payload volume, payload dimensions, delivery time windows, and regulatory compliance constraints. In an exemplary embodiment, the plurality of load tenders are geographically distributed across a national or international geography (e.g., the Continental United States), each load tender representing a load type, associated accessorials, and delivery requirements at a distinct origin location. The AI Engine 242 sequentially examines each geographically distributed load tender for compatibility with preceding load tenders, progressively imposing boundary conditions to build maximum capacity loads across the one or more transport vehicles. The time and human resources currently necessary to manually build an individual maximum capacity load for a single transport vehicle can take up to days to accomplish, and this complexity is further compounded when building maximum capacity loads across an intermodal transport fleet. The AI Engine 242 eliminates this manual effort by autonomously performing the sequential compatibility analysis across all geographically distributed load tenders. While this process begins as a stochastic analysis, it progresses deterministically with each sequential load tender as the associated boundary conditions are imposed. The AI Engine 242 generates a maximum capacity loading manifest that assigns the plurality of load tenders across one or more transport vehicles of one or more recommended transport carrier modalities. Cost effectiveness of maximum capacity loading is achieved by optimizing demand forecasting and capacity planning in real-time via the trained AI model. Major advantages of maximum capacity loading include reductions in fleet size, cost of operations, number of drivers and operators, number of load handlers and equipment, and infrastructure erosion. Maximum capacity loading considers how load tender types are manifested between individual or intermodal transport vehicles, including any single or combination load type such as pick only, pick and drop, and drop only. The AI Engine 242 can also operate in combination with load tenders received through load boards from individual shippers and brokers (e.g., the user computing devices 102A-102N), which adds greater capacity planning within the logistics chain but further increases complexity in determining individual or maximum capacity loading. After building a maximum capacity loading, the AI Engine 242 can autonomously, without direct human contact, create contract rate agreements for all individual parties, escrow the funds, create the optimum manifest, and manage the vehicles, operators, passenger, and freight distribution through the engines of the Transactional Layer and cloud-connected mobile applications.

The Cost Engine 244 is configured to receive transit profile data from the Manifest Engine 240 and optimized payload transport solution data from the AI Engine 242, and to determine one or more parameters that influence the costs of deploying physical and human assets for each leg of the transit profile 210. The Cost Engine 244 queries the transport carrier profiles 208 in the database 206 and data from the external data sources 110A-110N (e.g., fuel and energy pricing data) to calculate cost elements including, but not limited to, base transportation costs, fuel surcharges, energy costs for electric and alternative-fuel vehicles, operator labor costs, equipment costs, toll and permit fees, and lifecycle costs associated with vehicle utilization and depreciation. The Cost Engine 244 further assesses cost risks associated with each transit profile 210, including risks of delay penalties, detention charges, and accessorial cost overruns. The Cost Engine 244 generates interim cost data comprising at least profit margins, cost risks, fuel surcharge calculations, and lifecycle cost assessments, and passes the interim cost data to the Pricing Engine 246 for further processing.

In the real-world shipping order example, the Cost Engine 244 receives the transit profile data and the optimized payload transport solution for the selected second modality (electric truck plus refrigerated rail) and determines the following cost elements for each leg: for Leg 1 (Philadelphia to Chicago, electric refrigerated truck, Carrier A), a base transportation cost of $1,800, an electricity cost of $320 based on current charging station rates along the I-76/I-80 corridor, an operator labor cost of $650 for the estimated 14-hour drive time with required rest periods, and a refrigeration equipment surcharge of $200; for Leg 2 (Chicago to San Bernardino, refrigerated rail, Rail Operator B), a base rail transportation cost of $2,100, a refrigerated rail car surcharge of $450, and an intermodal terminal handling fee of $175 at each terminal; for Leg 3 (San Bernardino to Los Angeles, electric refrigerated truck, Carrier C), a base transportation cost of $280, an electricity cost of $35, and an operator labor cost of $120. The Cost Engine 244 further assesses cost risks including: a risk of detention charges of $75 per hour at the Chicago intermodal terminal if the rail car departure is further delayed beyond the 12-hour delay already factored into the transit profile, a risk of a temperature excursion penalty if the cold chain is broken during transloading at the Chicago or San Bernardino terminals, and a risk of an accessorial cost overrun for the temperature monitoring service if additional data loggers are required. The Cost Engine 244 generates interim cost data comprising a total estimated base cost of $6,330, a profit margin target of $640, a cost risk reserve of $480, and fuel surcharge and lifecycle cost assessments, and passes the interim cost data to the Pricing Engine 246.

The Pricing Engine 246 is configured to receive the interim cost data from the Cost Engine 244 and generate pricing for the optimized logistics solution. The Pricing Engine 246 calculates rate estimates for Less Than Truckload (LTL) and Truckload (TL) shipments, including all accessorials identified by the Accessorials Engine 236. The Pricing Engine 246 applies pricing rules, margin targets, and competitive rate data to produce a final price for each transit profile 210. The output of the Pricing Engine 246 is passed to the Transport Gap Engine 248 and to the Operations Engine 250 for validation, and subsequently to the Contracts Engine 252 of the Transactional Layer.

In the real-world shipping order example, the Pricing Engine 246 receives the interim cost data from the Cost Engine 244 and calculates a truckload rate estimate for the pharmaceutical cold chain shipment. The Pricing Engine 246 applies the base cost of $6,330, adds the five identified accessorial charges (temperature-controlled transport surcharge of $450, temperature monitoring service of $180, signature-required delivery of $35, detention allowance of $150, and pharmaceutical handling surcharge of $275), applies the profit margin target of $640, and applies competitive rate data indicating that comparable Philadelphia-to-Los Angeles refrigerated intermodal shipments are currently priced between $6,800 and $8,200 in the market. The Pricing Engine 246 produces a final price of $8,060 for the optimized logistics solution, which falls within the shipper's $8,500 cost constraint. The final price of $8,060 is passed to the Transport Gap Engine 248 and to the Operations Engine 250 for validation.

The Transport Gap Engine 248 is configured to examine potential physical limitations in the transport chain, including impractical or impossible solutions. The Transport Gap Engine 248 receives the transit profiles 210, the optimized payload transport solutions from the AI Engine 242, and the pricing data from the Pricing Engine 246, and computationally evaluates each leg of each transit profile to identify one or more transport gaps. A transport gap comprises a leg of the transit profile 210 for which no single transport carrier modality is capable of providing transport service due to at least one of a constraint on time, infrastructure, or price. For example, a transport gap may arise where a road network does not connect two points requiring a waterway or air segment, where no available transport carrier vehicle has sufficient range to complete a leg without refueling or recharging infrastructure, or where the cost of a particular leg exceeds the pricing constraints of the shipping order.

In response to identifying one or more transport gaps, the Transport Gap Engine 248 passes the identified transport gaps and the transit profile 210 to the AI Engine 242, which generates an intermodal transfer solution that assigns a replacement transport carrier modality to each identified transport gap leg while optimizing for minimum schedule delay and minimum cost across all remaining legs of the transit profile 210. The Manifest Engine 240 then updates the transit profile 210 stored in the database 206 to incorporate the intermodal transfer solution, producing a revised transit profile with zero transport gaps. The processing in the Transport Layer loops through the Modality Engine 238, the Manifest Engine 240, the AI Engine 242, the Cost Engine 244, the Pricing Engine 246, and the Transport Gap Engine 248 iteratively until a transit profile 210 with zero gaps, acceptable pricing, and that meets all operational requirements is produced.

In the real-world shipping order example, the Transport Gap Engine 248 receives the transit profile for the selected second modality (electric truck plus refrigerated rail) and computationally evaluates each leg. The Transport Gap Engine 248 identifies one transport gap: the electric refrigerated truck assigned to Leg 1 (Philadelphia to Chicago, Carrier A) has an operational range of 350 miles on a single charge, but the total distance of Leg 1 is approximately 760 miles, and the available DC fast-charging stations along the I-76/I-80 corridor that can accommodate a Class 8 electric truck are spaced at intervals that would require three charging stops of approximately 45 minutes each, extending the Leg 1 transit time to an estimated 18 hours and risking a breach of the operator's available hours-of-service window before reaching Chicago. The Transport Gap Engine 248 identifies this as a transport gap due to a constraint on time (hours-of-service) and infrastructure (charging station spacing). The Transport Gap Engine 248 passes the identified transport gap and the transit profile to the AI Engine 242, which generates an intermodal transfer solution: replace the single electric truck for the full Philadelphia-to-Chicago leg with a two-segment solution comprising an electric refrigerated truck from Philadelphia to a carrier relay point in Harrisburg, Pennsylvania (approximately 105 miles, well within single-charge range), and a diesel refrigerated truck from Harrisburg to Chicago (approximately 655 miles, with standard fuel stops). The Manifest Engine 240 updates the transit profile 210 in the database 206 to incorporate this intermodal transfer solution, producing a revised transit profile with four legs and zero transport gaps. The revised transit profile is re-processed through the Cost Engine 244 and Pricing Engine 246, yielding a revised final price of $8,180 (reflecting the slightly higher cost of the diesel truck segment), which remains within the shipper's $8,500 cost constraint.

The Operations Engine 250 is configured to examine the impact on transportation as affected by non-carrier and human factors. The Operations Engine 250 receives the transit profile 210, optimized payload transport solution, and pricing data from the preceding engines and evaluates operational feasibility by considering factors including, but not limited to, IoT device availability and connectivity status of the assigned transport carrier vehicles 108A-108N, infrastructure availability (e.g., dock availability, terminal capacity, runway availability, port scheduling), environmental factors (e.g., weather conditions, seasonal restrictions, natural disaster impacts), regulatory compliance requirements (e.g., hours-of-service regulations, customs and border requirements, hazardous material permits, jurisdictional operating authorities), and human resource availability (e.g., driver availability, operator certifications, labor scheduling constraints). The Operations Engine 250 receives relevant data from the external data sources 110A-110N via the receiving device 202 and from the transport carrier profiles 208 stored in the database 206. If the Operations Engine 250 identifies operational feasibility issues, the issues are fed back to the AI Engine 242 for re-optimization. Once the Operations Engine 250 confirms operational feasibility, the results of the Pricing Engine 246 and Operations Engine 250 are passed to the Transactional Layer for contract execution.

In the real-world shipping order example, the Operations Engine 250 receives the revised transit profile with four legs and zero transport gaps and evaluates operational feasibility. The Operations Engine 250 confirms the following: the electric refrigerated truck assigned to Leg 1 (Philadelphia to Harrisburg) operated by Carrier A is equipped with IoT devices interfaced with the vehicle's ECU and has active cellular and satellite connectivity; the diesel refrigerated truck assigned to Leg 2 (Harrisburg to Chicago) operated by Carrier A has a qualified operator available with 9.5 hours remaining on the operator's daily hours-of-service clock, sufficient for the estimated 8.5-hour drive time; the intermodal terminal at the Chicago rail yard has a refrigerated transloading bay available at the scheduled arrival time; Rail Operator B has confirmed a refrigerated rail car departure from Chicago within 6 hours of the scheduled payload arrival at the Chicago terminal; the electric refrigerated truck assigned to Leg 4 (San Bernardino to Los Angeles) operated by Carrier C is available and has a qualified operator with valid California Air Resources Board (CARB) compliance certification; and no severe weather events, road closures, or regulatory restrictions are forecasted along any leg of the revised transit profile during the transit window. The Operations Engine 250 confirms operational feasibility with no issues identified and passes the results, together with the final price of $8,180 from the Pricing Engine 246, to the Transactional Layer for contract execution.

### Transactional Layer

FIG. 2C continues the block diagram of the logistics optimization program 218, illustrating the Transactional Layer and the Enroute Layer. The Transactional Layer of the logistics optimization program 218 uses various engines for contract execution, document management, financial processing, and distribution, but without the need for interoperability with the AI Engines 220. The validity of the resulting output from the Transactional Layer engines requires sequential processing and credible data from the Transport Layer. The Transactional Layer includes a Contracts Engine 252, a Documents Engine 254, a Finance Engine 256, a Communications module 258, and a Distribution Engine 260.

The Contracts Engine 252 is configured to receive the results from the Pricing Engine 246 and Operations Engine 250 and to perform automatic assimilation of contract terms. The Contracts Engine 252 generates contract rate agreements for each party involved in the optimized logistics solution, including shippers, brokers, carriers, and any other parties identified in the transit profile 210. In embodiments involving maximum capacity loading with load tenders from multiple shippers and brokers, the Contracts Engine 252 autonomously creates individual contract rate agreements for all individual parties. The Contracts Engine 252 incorporates the pricing from the Pricing Engine 246, the accessorials from the Accessorials Engine 236, the operational requirements from the Operations Engine 250, and the transport carrier assignments from the optimized logistics solution into the contract terms. The Contracts Engine 252 queries the client profiles 212 stored in the database 206 to retrieve contract term thresholds, fee structure configurations, and payment arrangement preferences for each party. The generated contract records can be stored in the database 206 and passed to the Documents Engine 254.

In the real-world shipping order example, the Contracts Engine 252 receives the confirmed operational feasibility results and the final price of $8,180. The Contracts Engine 252 generates three separate contract rate agreements: (1) a contract between the shipper and the logistics platform for the total shipment at a rate of $8,180, incorporating the five identified accessorials, a delivery deadline of five calendar days, and a temperature maintenance requirement of 2° C. to 8° C. with a penalty clause for cold chain breach; (2) a contract between the logistics platform and Carrier A for Legs 1 and 2 (Philadelphia to Harrisburg by electric truck and Harrisburg to Chicago by diesel truck, including transloading at the Chicago intermodal terminal) at a combined carrier rate incorporating the operator labor costs and fuel/electricity costs determined by the Cost Engine 244; and (3) a contract between the logistics platform and Rail Operator B for Leg 3 (Chicago to San Bernardino by refrigerated rail) and Carrier C for Leg 4 (San Bernardino to Los Angeles by electric truck) at their respective carrier rates. Each contract incorporates the applicable accessorial charges, hours-of-service compliance requirements, temperature monitoring obligations, and payment terms retrieved from the client profiles 212 of each party. The generated contract records are stored in the database 206 and passed to the Documents Engine 254.

The Documents Engine 254 is configured to receive contract records from the Contracts Engine 252 and to prepare and transmit electronic contract documents for electronic signature and/or any other suitable execution. The Documents Engine 254 generates updated electronic contract documents based on the contract terms and transmits the electronic contract documents via the transmitting device 222 over the communication network to one or more party devices (e.g., user computing devices 102A-102N and transport carrier servers 106A-106N) for electronic signature. In embodiments, the Documents Engine 254 further generates and manages additional transit documents including, but not limited to, Bills of Lading, shipping manifests, customs declarations, hazardous material shipping papers, and other regulatory documents required for the assigned transport carrier modalities. Dependent upon contract terms and the receipt of executed electronic signatures, the process flows to either the Finance Engine 256 or the Distribution Engine 260.

In the real-world shipping order example, the Documents Engine 254 receives the three contract records from the Contracts Engine 252 and generates the following electronic documents: three electronic contract documents (one for the shipper, one for Carrier A, and one for Rail Operator B/Carrier C) prepared for electronic signature; a Bill of Lading for the pharmaceutical cold chain shipment specifying the payload of 12 pallets of pharmaceutical products, the temperature requirement of 2° C. to 8° C., and the chain-of-custody requirements; a four-leg shipping manifest detailing the payload, assigned carriers, assigned vehicles, scheduled pickup and transfer times, and routing instructions for each leg; and a temperature monitoring compliance document specifying the data logger requirements and reporting intervals. The Documents Engine 254 transmits the electronic contract documents via the transmitting device 222 to the shipper's user computing device 102A, to Carrier A's transport carrier server 106A, and to Rail Operator B's and Carrier C's transport carrier servers 106B and 106C for electronic signature. Upon receipt of all executed electronic signatures, the process flows to the Finance Engine 256.

The Finance Engine 256 is configured to execute one or more automated financial transactions based on the contract terms. The Finance Engine 256 processes financial transactions via the communication network through the transmitting device 222 and receiving device 202. The one or more automated financial transactions can include at least one of Electronic Data Interchange (EDI) transactions and Automated Clearing House (ACH) transactions. In embodiments involving maximum capacity loading, the Finance Engine 256 can escrow funds for all individual parties associated with a maximum capacity loading manifest prior to dispatch. The Finance Engine 256 can record all financial transaction records in the database 206, e.g., in a client profile 212. In embodiments, the Finance Engine 256 interfaces with financial processing networks of the external data sources 110A-110N to execute payment processing, fund transfers, and escrow management.

In the real-world shipping order example, the Finance Engine 256 receives the executed contract terms and processes the following automated financial transactions: an EDI transaction initiating a charge of $8,180 against the shipper's payment method on file in the client profile 212; an ACH escrow transaction placing the carrier payment amounts into escrow accounts pending proof of delivery, the escrowed amounts comprising the contracted rate for Carrier A (Legs 1 and 2), the contracted rate for Rail Operator B (Leg 3), and the contracted rate for Carrier C (Leg 4); and an EDI transaction recording the accessorial charges allocated to each carrier contract. The Finance Engine 256 records all financial transaction records in the database 206 in the respective client profiles 212 of the shipper, Carrier A, Rail Operator B, and Carrier C.

The Communications module 258 is configured to provide automated real-time data sharing and interoperability via authorized mobile applications, internet devices, and radio telemetry. The Communications module 258 operates in conjunction with the transmitting device 222 and the receiving device 202 to facilitate communications between the processing server 104 and all parties and devices in the system 100. In embodiments, the Communications module 258 supports one or more communication protocols including wide area networks (WAN), 4G/5G cellular networks, Wi-Fi, UHF, Bluetooth including Bluetooth Low Energy, near-field communications, and other communications protocols known in the art. The Communications module 258 provides the communication infrastructure used by the Distribution Engine 260 and the Enroute Layer to exchange data with the transport carrier vehicles 108A-108N, the transport carrier servers 106A-106N, and the user computing devices 102A-102N in real time. In embodiments, one or more passengers are provided with various mobile applications for ticketing, scheduling, and ride transfers via the Communications module 258. Additionally, logistics operators are provided with a range of mobile solutions for end-to-end logistics management of truckload (TL) and less-than-truckload (LTL) transportation via the Communications module 258.

The Distribution Engine 260 is configured to automatically distribute a final manifest, required transit documents, and mobile and internet access to either the passenger or freight management system (e.g., the transport carrier servers 106A-106N). The Distribution Engine 260 receives the executed contract documents from the Documents Engine 254 and the final manifest data from the transit profiles 210 stored in the database 206, and distributes the final manifest, required transit documents, and access credentials to the appropriate parties via the transmitting device 222 over the communication network. The Distribution Engine 260 transmits electronic dispatch instructions to the transport carrier servers 106A-106N and, where applicable, directly to the transport carrier vehicles 108A-108N. The Distribution Engine 260 is further configured to automatically distribute alert notifications regarding shipment status, incipient failures, estimated completion schedules, and corrective routing actions to one or more devices associated with one or more of a carrier, a broker, a shipper, and a receiver. In embodiments, the Distribution Engine 260 distributes revised manifests and updated alert notifications in response to corrective routing actions generated by the Enroute Layer, as described below. In embodiments, the Distribution Engine 260 interfaces with a proprietary freight management system that provides autonomous LTL and TL shipment management including accessorials and compliance, backhaul manifests, Bills of Lading, route optimization, driver eLog and Electronic Logging Devices, fleet and driver management, human resources, ERP, dock management, safety lane, maintenance management, real-time diagnostic analyses, and other features. The Distribution Engine 260 can also interface with other third-party transportation support systems.

In the real-world shipping order example, the Distribution Engine 260 receives the executed contract documents and the final four-leg manifest from the database 206 and distributes the following: to the shipper's user computing device 102A, the executed contract, the Bill of Lading, the full shipping manifest, and a shipment tracking access link; to Carrier A's transport carrier server 106A, electronic dispatch instructions for Legs 1 and 2 including pickup time at the Philadelphia warehouse, routing instructions to the Harrisburg relay point and then to the Chicago intermodal terminal, the operator hours-of-service compliance schedule, and the temperature monitoring requirements; to Rail Operator B's transport carrier server 106B, electronic dispatch instructions for Leg 3 including the scheduled cargo arrival time at the Chicago intermodal terminal, the refrigerated rail car assignment, and the destination terminal in San Bernardino; to Carrier C's transport carrier server 106C, electronic dispatch instructions for Leg 4 including the scheduled cargo arrival time at the San Bernardino terminal and routing instructions to the Los Angeles distribution center; and to the receiver's user computing device 102N, an alert notification of the incoming shipment with the estimated delivery time and signature-required delivery instructions. The Distribution Engine 260 transmits the dispatch instructions and initiates the Enroute Layer monitoring.

### Enroute Layer

The Enroute Layer of the logistics optimization program 218 provides various levels of corrective action dependent upon dynamically changing inputs received during transit execution. The Enroute Layer includes an Enroute Engine 262, a Change Engine 264, and a second AI Engine of the AI Engines 220, identified in FIG. 2C as AI Engine 268. The Enroute Layer operates after the Distribution Engine 260 has dispatched the transport carrier vehicles 108A-108N in accordance with the optimized logistics solution.

The Enroute Engine 262 is configured to receive a plurality of real-time operational data items from the transport carrier vehicles 108A-108N via the receiving device 202 over the one or more communication networks. The real-time operational data is transmitted by the one or more IoT devices physically interfaced with the ECU or PCM of each transport carrier vehicle 108A-108N, as described above with reference to FIG. 1. The real-time operational data can include, for example, at least one of vehicle diagnostic data, operator control inputs, positional data, incipient failure signals, environmental sensor data, and autonomous control inputs. An in-vehicle IoT electronics device connected to the PCM/ECU provides valuable information such as incipient failures, vehicle operations, and operator or autonomous control inputs that may conflict with client requirements of the shipping order. The Enroute Engine 262 assesses the real-time operational data in the context of the active transit profile 210 stored in the database 206, evaluating transit status, incipient failures, unforeseen contingencies, and projected schedules. The Enroute Engine 262 compares the real-time operational data against the transit profile to identify potential deviations from the shipping order requirements. When the Enroute Engine 262 detects a potential deviation or anomaly, the relevant real-time operational data items are fed to the Change Engine 264 for preprocessing.

In the real-world shipping order example, after dispatch, the Enroute Engine 262 begins receiving real-time operational data from the IoT devices on the transport carrier vehicles. During Leg 2 (Harrisburg to Chicago, diesel refrigerated truck), the Enroute Engine 262 receives the following real-time operational data items from the IoT device interfaced with the truck's ECU: GPS positional data indicating the truck is traveling westbound on I-80 near Clearfield, Pennsylvania; vehicle diagnostic data indicating normal engine performance; refrigeration unit sensor data reporting a cargo compartment temperature of 5° C. within the required 2° C. to 8° C. range; and an incipient failure signal from the refrigeration unit's compressor indicating an abnormal vibration pattern consistent with early-stage compressor bearing wear. The Enroute Engine 262 assesses this real-time operational data against the active transit profile and identifies a potential deviation: the incipient compressor failure signal suggests the refrigeration unit may fail before the truck reaches Chicago (approximately 6 hours of driving remaining), which would cause the cargo compartment temperature to rise above the 8° C. cold chain threshold and breach the shipping order's temperature requirement. The Enroute Engine 262 feeds the incipient failure signal and associated operational data to the Change Engine 264.

The Change Engine 264 is configured to receive the real-time operational data items from the Enroute Engine 262 and perform preprocessing prior to submission to the AI Engine 268. The preprocessing by the Change Engine 264 can include data normalization, filtering, and structuring of the real-time operational data into a format suitable for decomposition into influence-variable matrices by the AI Engine 268. The Change Engine 264 submits the preprocessed data to the AI Engine 268 to determine the resulting impact of the detected deviation and to generate a corrective routing action.

In the real-world shipping order example, the Change Engine 264 receives the incipient compressor failure signal and associated operational data from the Enroute Engine 262 and performs preprocessing. The Change Engine 264 normalizes the vibration frequency data from the compressor sensor, filters out transient noise spikes in the diagnostic data, and structures the preprocessed data into a format comprising: the current vehicle position (GPS coordinates near Clearfield, PA), the current cargo temperature (5° C.), the compressor vibration trend data (increasing amplitude over the preceding 45 minutes), the estimated time to compressor failure based on the vibration rate of change, the remaining distance to Chicago (approximately 420 miles), the remaining operator hours-of-service (6.5 hours), and the current ambient outside temperature (82° F.). The Change Engine 264 submits this preprocessed data to the AI Engine 268.

The AI Engine 268 is the second AI Engine of the AI Engines 220 and is configured to provide the analytical and numerical processing for the Enroute Layer. The AI Engine 268 shares the AI Engine core processing components described above with reference to FIG. 2D, i.e., the four overall processes of accepting input data, examining the data for pattern recognition, adapting the data into mathematical algorithms, and providing predictive analytics. In embodiments, the AI Engine 268 comprises a trained AI model that is created and trained by the processing server 104 using historical logistics datasets and resulting operational data stored in the database 206. In alternative embodiments, the AI Engine 268 utilizes a commercially available AI model accessed by the processing server 104 via one or more APIs over the communication network. Where the AI Engine 268 utilizes a commercially available AI model, the processing server 104 assembles the preprocessed real-time operational data, influence-variable matrices, and other input parameters into RAG prompts by retrieving relevant context data from the database 206, including historical records of similar incipient failure events, corrective routing actions previously generated for comparable logistics gap conditions, and transport carrier profiles 208 for available replacement vehicles in the geographic vicinity of the detected deviation, and combining the retrieved context data with the current input data into structured prompts that are transmitted to the commercially available AI model. The commercially available AI model processes the RAG prompts and returns corrective routing actions and predictive analytics that the processing server 104 integrates into the Enroute Layer for execution.

Upon receiving the preprocessed data from the Change Engine 264, the AI Engine 268 decomposes the real-time operational data into a plurality of influence-variable matrices using at least one data manipulation technique, for example, Singular Value Decomposition, Markov models, and/or neural networks. The decomposing reduces dimensionality of the real-time operational data and separates deterministic operational variables from stochastic environmental variables. The AI Engine 268 applies pattern recognition to the plurality of influence-variable matrices to identify a logistics gap condition. A logistics gap condition can include a deviation between the active transit profile 210 and one or more requirements of the shipping order, including at least one of a schedule deviation, an infrastructure constraint, an incipient vehicle failure, or a contested logistics scenario in which an adversarial disruption, delay, or discontinuation of any portion of the supply chain is detected.

In response to identifying the logistics gap condition, the AI Engine 268 generates a corrective routing action. The corrective routing action can include, for example, a re-routing instruction, a modality substitution recommendation, and/or a load manifest revision. In generating the corrective routing action, the AI Engine 268 evaluates a plurality of candidate corrective routing actions and selects an optimal corrective routing action from among the plurality of candidate corrective routing actions. For each identified logistics gap condition, the AI Engine 268 generates the plurality of candidate corrective routing actions by querying the transport carrier profiles 208 stored in the database 206 to identify available replacement transport carrier vehicles, alternative routes, and substitute transport carrier modalities within a geographic proximity of the detected deviation, and by computing, for each candidate corrective routing action, a projected impact on the active transit profile 210 across a plurality of optimization criteria including at least schedule delay, cost, payload safety, cold chain or environmental compliance, regulatory compliance, and available asset utilization. The AI Engine 268 inputs the plurality of candidate corrective routing actions with their corresponding projected impacts into the trained AI model, which applies the plurality of optimization criteria as boundary conditions and outputs a ranking of the plurality of candidate corrective routing actions. The AI Engine 268 selects the optimal corrective routing action as the candidate corrective routing action that minimizes a combined objective function across the plurality of optimization criteria while maintaining compliance with the requirements of the shipping order. For example, in response to an incipient vehicle failure identified via pattern recognition of IoT sensor data, the AI Engine 268 may generate candidate corrective routing actions including rerouting the transport carrier vehicle to a nearby repair facility for emergency maintenance, substituting the transport carrier vehicle with a replacement vehicle of the same transport carrier modality at a carrier relay point, redistributing the payload across a plurality of smaller transport carrier vehicles available in the geographic vicinity, and switching to an alternative transport carrier modality (e.g., from a land vehicle to an aircraft) to recover schedule margin. The AI Engine 268 evaluates each candidate against the boundary conditions of the shipping order and selects the optimal corrective routing action that best preserves the delivery schedule, cost constraints, and payload integrity requirements. In embodiments involving a contested logistics scenario in which the logistics gap condition comprises an adversarial disruption, delay, or discontinuation of any portion of the supply chain, the AI Engine 268 generates the plurality of candidate corrective routing actions with additional consideration of adversarial threat assessment, supply chain redundancy, and geographic avoidance parameters. In such contested logistics scenarios, the AI Engine 268 queries the external data sources 110A-110N and the transport carrier profiles 208 to identify unaffected portions of the carrier network, evaluates candidate corrective routing actions that reroute the payload around the contested segment via alternative geographic corridors, substitute transport carrier modalities that are not subject to the adversarial disruption (e.g., substituting an air modality for a land modality where a road corridor is compromised), or redistribute the payload across multiple redundant transport paths to mitigate the risk of further adversarial disruption. The AI Engine 268 applies the same combined objective function optimization to the contested logistics candidate corrective routing actions, with the additional boundary condition of minimizing exposure to the identified adversarial threat, and selects the optimal corrective routing action accordingly. The computational feedback loop illustrated in FIG. 2E stores the identified logistics gap condition, the plurality of candidate corrective routing actions evaluated, the selected optimal corrective routing action, and the resulting operational outcome in the database 206 as part of the historical logistics datasets, enabling the trained AI model to improve its evaluation and ranking of candidate corrective routing actions for future logistics gap conditions of similar type and geographic context.

In the real-world shipping order example, the AI Engine 268 receives the preprocessed data from the Change Engine 264 and decomposes the data into influence-variable matrices. The AI Engine 268 separates the deterministic operational variables (current vehicle position, remaining distance to Chicago, current cargo temperature, operator remaining hours-of-service) from the stochastic environmental variables (rate of compressor degradation, ambient temperature variation along the remaining route, traffic conditions ahead on I-80). The AI Engine 268 applies pattern recognition and identifies a logistics gap condition comprising an incipient vehicle failure: the compressor vibration pattern matches historical failure profiles in the trained AI model's dataset, and the AI Engine 268 predicts with high confidence that the refrigeration compressor will fail within approximately 2.5 hours, after which the cargo temperature will rise above 8° C. within approximately 45 minutes given the current ambient temperature of 82° F. and the insulation characteristics of the trailer. This predicted failure would occur approximately 280 miles before reaching Chicago, resulting in a cold chain breach that violates the shipping order requirements. In response, the AI Engine 268 generates a corrective routing action comprising: (1) a re-routing instruction directing the truck to exit I-80 at the next exit and proceed to a refrigerated carrier relay facility in DuBois, Pennsylvania, approximately 15 miles ahead; and (2) a modality substitution recommendation to transfer the 12 pallets from the current diesel refrigerated truck to a replacement diesel refrigerated truck operated by Carrier D, which the AI Engine 268 has identified as available at the DuBois facility based on the transport carrier profiles 208 queried from the database 206, with a functional refrigeration unit and an operator with a full hours-of-service clock. The corrective routing action maintains the cold chain by minimizing the time between detection and vehicle substitution (estimated 20 minutes to reach the DuBois facility) and preserves the overall schedule by enabling the replacement truck to continue directly to Chicago with an estimated arrival only 1.5 hours behind the original schedule, which remains within the five-day delivery window.

FIG. 2E is a block diagram illustrating the computational feedback loop implemented by the AI Engines 220, including both the AI Engine 242 and the AI Engine 268. The computational feedback loop comprises a closed-loop data path in which input data flows into the AI Engines 220, is processed through pattern recognition to identify trends and relationships, is subjected to computational adaptation in which the AI Engines 220 adapt the data into appropriate mathematical algorithms and models, and produces predictive analytics outputs. The predictive analytics outputs and resulting operational data are then fed back into the input, creating a generative, machine-learning dataset that continuously improves the trained AI model of the AI Engines 220. In embodiments where the AI Engines 220 utilize commercially available AI models, the computational feedback loop feeds resulting operational data back to the processing server 104, which updates the context data stored in the database 206 used to assemble RAG prompts, thereby continuously improving the relevance and accuracy of the context data retrieved for future RAG prompts submitted to the commercially available AI models.

The computational feedback loop serves two primary purposes. First, the feedback loop funnels resulting data back into the input to create a generative, machine-learning dataset. Resulting operational data generated during execution of the optimized logistics solution (e.g., actual transit times, actual fuel or energy consumption, actual route deviations, delivery completion timestamps, corrective routing actions taken, and proof of delivery records) is collected by the processing server 104 and stored in the database 206 as part of the historical logistics datasets (e.g., in the transport carrier profiles 208). This resulting operational data is appended to the training dataset stored in the database 206, and the trained AI models of the AI Engines 220 are retrained or fine-tuned using the updated training dataset to improve predictive accuracy of future optimized payload transport solutions. Second, the feedback loop provides real-time adjustments, proactive corrections, and amplifies future options which automatically resolve unforeseen contingencies such as contested logistics. In the context of the AI Engine 268, the feedback loop feeds the plurality of influence-variable matrices back through the trained AI model, updating predictive analytics models and adapting mathematical algorithms to produce an optimized corrective solution in response to the identified logistics gap condition.

Any changes provided by the AI Engine 268 via the Change Engine 264 are provided back through the Contracts Engine 252 for contract updates. The Contracts Engine 252 automatically updates the contract terms stored in the database 206 to reflect the corrective routing action, and the updated contract terms continue through the Documents Engine 254 for generation of updated electronic contract documents, the Finance Engine 256 for execution of any additional or revised financial transactions, and the Distribution Engine 260 for distribution of a revised manifest and alert notifications to all affected parties (e.g., the user computing devices 102A-102N and/or the transport carrier servers 106A-106N) before a revised solution is passed back into the Enroute Engine 262. This closed-loop feedback path between the Enroute Layer and the Transactional Layer ensures that all contractual, financial, and documentary records remain synchronized with the actual operational state of the transit at all times.

In the real-world shipping order example, in response to the corrective routing action generated by the AI Engine 268, the Contracts Engine 252 automatically updates the contract terms to reflect the modality substitution: the contract with Carrier A is amended to terminate Leg 2 at DuBois, Pennsylvania instead of Chicago, and a new contract is generated with Carrier D for the replacement Leg 2 segment from DuBois to Chicago at the carrier rate retrieved from Carrier D's transport carrier profile 208. The Documents Engine 254 generates an updated Bill of Lading reflecting the vehicle substitution and chain-of-custody transfer at DuBois and generates an amended shipping manifest showing the revised four-leg route with Carrier D replacing Carrier A for the DuBois-to-Chicago segment. The Finance Engine 256 executes an ACH transaction adjusting the escrowed carrier payments to reflect the amended carrier rates. The Distribution Engine 260 distributes the revised manifest and alert notifications to all affected parties: the shipper's user computing device 102A receives an alert notification indicating the vehicle substitution due to an equipment issue, along with the updated estimated delivery time; Carrier A's transport carrier server 106A receives updated dispatch instructions confirming the truncated Leg 2 termination at DuBois; Carrier D's transport carrier server 106D receives new dispatch instructions for the replacement DuBois-to-Chicago segment; and the receiver's user computing device 102N receives an updated estimated delivery time notification. The revised solution is passed back into the Enroute Engine 262 for continued monitoring of the replacement vehicle through the remainder of the transit.

The corrective routing action is transmitted by the transmitting device 222 as an electronic control signal via the Communications module 258 to the transport carrier vehicle 108A-108N over at least one communication channel selected from the group consisting of a wide area network (WAN), a 4G/5G cellular network, Wi-Fi, UHF, and Bluetooth Low Energy. The one or more IoT devices of the transport carrier vehicle receive the electronic control signal and, where authorized, write the corrective routing action to the ECU or PCM of the transport carrier vehicle via one or more hardware sensor buses, thereby enabling closed-loop feedback control including autonomous operations and Beyond Visual Line of Sight (BVLOS) capabilities.

Upon successful completion of payload transport in accordance with the optimized logistics solution or as revised by one or more corrective routing actions, the Enroute Engine 262 receives confirmation data from the transport carrier vehicle 108A-108N via the one or more IoT devices, indicating delivery of the payload at the payload destination. The Enroute Engine 262 generates a proof of delivery record at Proof of Delivery 266 and stores the proof of delivery record in the database 206 in association with the corresponding transit profile 210 and shipping order. The Distribution Engine 260 transmits a proof of delivery notification to the user computing devices 102A-102N associated with the shipper and receiver via the transmitting device 222 over the communication network. In embodiments, the proof of delivery record can include, for example, a timestamp of delivery, positional data confirming arrival at the payload destination, an electronic signature or acknowledgment from the receiver, and/or any exception or discrepancy data noted during delivery. The Finance Engine 256 may execute final financial transactions, including release of escrowed funds, upon confirmation of Proof of Delivery 266.

In the real-world shipping order example, the payload of 12 pallets of pharmaceutical products arrives at the Los Angeles distribution center via the electric refrigerated truck operated by Carrier C on Leg 4. The IoT device on Carrier C's vehicle transmits confirmation data to the processing server 104, including GPS positional data confirming arrival at the distribution center geocoordinates, a timestamp of delivery at 3:47 PM Pacific Time on day 4.6 of the five-day delivery window, a final cargo temperature reading of 4° C. (within the 2° C. to 8° C. requirement), and a continuous temperature log confirming that the cold chain was maintained throughout all four legs of transit including the vehicle substitution at DuBois. The receiver provides an electronic signature via a mobile application on the receiver's user computing device 102N, acknowledging receipt of all 12 pallets with no exceptions or discrepancies. The Enroute Engine 262 generates a proof of delivery record comprising the delivery timestamp, GPS confirmation, the receiver's electronic signature, the continuous temperature log, and the chain-of-custody documentation, and stores the proof of delivery record in the database 206. The Distribution Engine 260 transmits a proof of delivery notification to the shipper's user computing device 102A. The Finance Engine 256 executes final ACH transactions releasing the escrowed carrier payments to Carrier A (for Leg 1 and the amended Leg 2 to DuBois), Carrier D (for the replacement Leg 2 from DuBois to Chicago), Rail Operator B (for Leg 3), and Carrier C (for Leg 4).

The resulting operational data generated during execution of the optimized logistics solution is collected by the processing server 104 and stored in the database 206 as part of the historical logistics datasets. This resulting operational data is fed back into the trained AI model of the AI Engines 220 via the computational feedback loop illustrated in FIG. 2E, thereby continuously improving predictive accuracy of future optimized payload transport solutions.

In the real-world shipping order example, the processing server 104 collects the resulting operational data from the completed shipment, including: actual transit times for each of the four legs (with the vehicle substitution adding 1.5 hours to the original Leg 2 estimate), actual electricity consumption for the electric truck legs and actual diesel fuel consumption for the diesel truck leg, the actual route deviation caused by the DuBois detour, the compressor failure pattern data that triggered the corrective routing action, the temperature log data confirming successful cold chain maintenance throughout the transit, and the actual total cost of $8,340 (reflecting the Carrier D substitution cost). This resulting operational data is fed back into the trained AI models of the AI Engines 220 via the computational feedback loop. The compressor vibration pattern data from the incipient failure is appended to the historical dataset, improving the AI Engine 268's ability to identify similar compressor failure patterns earlier in future shipments. The successful corrective routing action (vehicle substitution at DuBois) is stored as a precedent, enabling the AI Engine 268 to more rapidly generate comparable corrective actions for future incipient refrigeration failures along the I-80 corridor. The actual transit time and cost data refine the AI Engine 242's predictive models for Philadelphia-to-Los Angeles refrigerated intermodal shipments, improving the accuracy of future optimized payload transport solutions for similar shipping orders. In embodiments where the AI Engines 220 utilize commercially available AI models, the resulting operational data is stored in the database 206 as updated context data, improving the relevance and accuracy of context data retrieved for future RAG prompts submitted to the commercially available AI models for similar shipping orders and logistics gap conditions.

The system 100 of the present invention includes design architecture consisting of reusable modules that can operate in totality or in numerous various combinations depending on desired outcome. The system 100 offers a flexible approach for data input and output within each of the four layers (e.g., the Client Layer, the Transport Layer, the Transactional Layer, and the Enroute Layer) such that the engines within each layer can accept input data and produce output data in configurable formats and sequences appropriate to the desired outcome. The system 100 has several applications outside of the initially intended transportation logistics whereby the invention can provide value. For example, warehouses can manage drop-shipping, blind shipping, private label shipping, and other uses that can support a fulfillment house. Private transportation services or in-house carrier fleets such as taxis, limousines, corporate motor pools, car dealerships, ride share companies, bus companies, campgrounds, universities, FAA Part 135 flight operators, construction companies, equipment rentals, and the like can all benefit from one to many of the modules of the logistics optimization program 218. All features within the logistics optimization program 218 are configurable through the secure administration object-oriented interface enforced via the client profiles 212 stored in the database 206, which enables rights management for each individual with accessibility to one or more functions.

The system 100 is usable by individual and business clients such as shippers, passengers, brokers, warehousers, carriers, and receivers that need to book travel arrangements or ship or receive goods. Clients access the processing server 104 from an internet-capable user computing device 102A-102N or mobile application. Passengers, shippers, and receivers use the system 100 to book, manage, send, and receive funds. Brokers and carriers are provided with additional platform features commensurate with their individual tasks associated with logistics transportation, as configured in the client profiles 212. Brokers can configure and manage identification of carrier modality fleets, rate estimates for LTL and TL shipments including all accessorials, contract agreements, fee structures, documents, payments, messaging, enroute management, customer support, compliance, and business intelligence reports. In addition, the system 100 offers transportation technologies that can be distributed by all vested third parties. Brokers can customize technologies that can be made available to individual parties within the transportation supply chain. Carriers can personalize their use of the system 100 for identifying posted bookings and loads, rate estimates for LTL and TL shipments, contract term thresholds, payment arrangements, notifications, and operator and vehicle compliance.

The system 100 can be reproduced by incorporating a combination of individual workflows throughout the logistics transportation process and either independently constructing some or all components or using a combination of third-party solutions directly or modified as necessary. The following procedures serve as a development guideline:
1. Digitally capture all client requirements via the Order Placement module 230 and store the shipping order in the database 206.
2. Create a library of one or more carrier modalities detailing all physical, operational, and performance characteristics, stored as transport carrier profiles 208 in the database 206.
3. Create a transit profile (manifest) via the Manifest Engine 240 to include the payload origin, the payload destination, and any additional intermediate stops enroute.
4. Create a library of individual carrier cost elements or integrate licensed third-party costing systems via the Cost Engine 244.
5. Compare the transit profile with each individual carrier's capabilities and cost via the AI Engine 242 and the Cost Engine 244.
6. Identify which segment (leg) of the transit profile is best served by a given carrier modality based on capabilities and cost via the AI Engine 242.
7. Determine transport gaps via the Transport Gap Engine 248 whereby any leg exists for which any carrier modality is incapable of providing transport service.
8. Conduct trade-offs via the AI Engine 242 examining the performance of the overall manifest by evaluating each leg to obtain delivery solutions yielding minimum schedule delay and minimum cost.
9. For configurations yielding a complete delivery solution, examine the impact to each carrier modality from outside influence factors such as infrastructure and compliance via the Operations Engine 250.
10. When a final solution is ascertained, execute contracts for electronic signature, electronic payment, and electronic distribution via the Contracts Engine 252, the Documents Engine 254, the Finance Engine 256, and the Distribution Engine 260.
11. Integrate the Communications module 258 to provide real-time alert notifications and data transfer between all parties and devices in the system 100.
12. Optionally implement ECU/PCM-interfaced IoT devices on the transport carrier vehicles 108A-108N for enroute status monitoring and corrective action via the Enroute Engine 262, the Change Engine 264, and the AI Engine 268.

### Process for Autonomous Orchestration of Intermodal Logistics Transportation

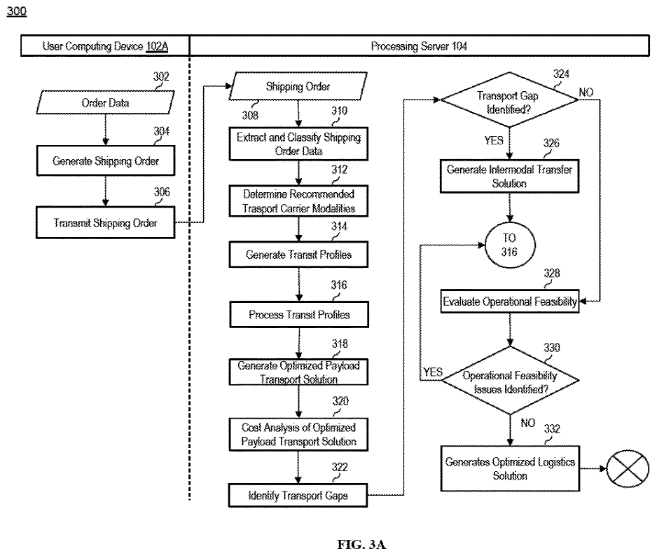

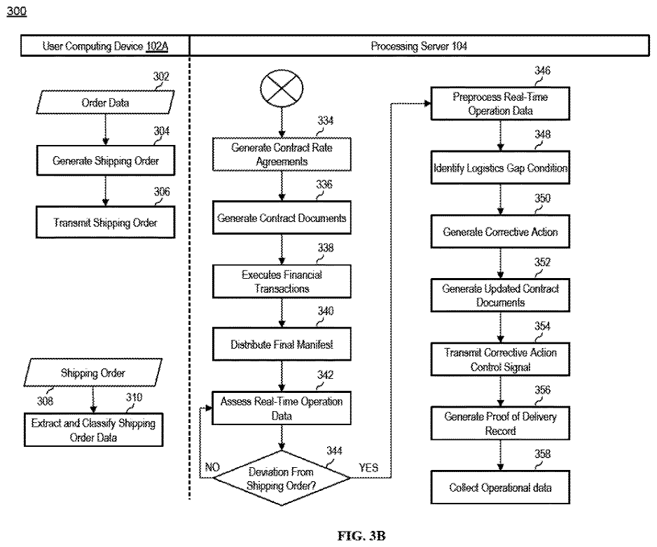

FIG. 3 illustrates process 300 for autonomous orchestration of intermodal logistics transportation via the system 100 of FIG. 1.

In step 302, a user operating a user computing device 102A gathers order data for a shipping order, the order data including at least a payload specification for a payload, shipment scheduling data, payload origin data, payload destination data, and payload shipment preference data.

In step 304, the user computing device 102A generates the shipping order including the order data and, in step 306, transmits the shipping order to the processing server 104 via a user interface over the one or more communication networks.

In step 308, the processing server 104 (e.g., via the receiving device 202) receives the shipping order from the user computing device 102A. The processing server 104 stores the shipping order in the database 206 and queries the client profiles 212 to verify the identity and authorization of the submitting user.

In step 310, the processing server 104 (e.g., via the Attributes Engine 232) extracts and classifies the order data from the shipping order. The processing server 104 parses the shipping order stored in the database 206 and extracts payload and transportation parameters, classifying the extracted parameters into categories corresponding to physical, operational, and regulatory attributes. In embodiments, the processing server 104 (e.g., via the Attributes Engine 232) receives supplemental attribute data from the external data sources 110A-110N and incorporates the supplemental attribute data into the extracted and classified order data. The processing server 104 (e.g., via the Actions Engine 234) determines one or more required operational actions for fulfilling the shipping order based on the classified output. The processing server 104 (e.g., via the Accessorials Engine 236) identifies applicable accessorial services based on the payload specification and shipment preferences and generates an accessorials data record associated with the shipping order in the database 206.

In step 312, the processing server 104 (e.g., via the Modality Engine 238) analyzes the extracted and classified order data and determines one or more recommended transport carrier modalities for transporting the payload. The processing server 104 queries the transport carrier profiles 208 stored in the database 206 to retrieve the carrier modality library and compares the payload specification against the capabilities of available transport carrier vehicles 108A-108N, eliminating from transport consideration each transport carrier vehicle incapable of supporting the payload specification based on at least one of weight, size, volume, or distance. The processing server 104 further considers attributes including energy type, speed, volume capacity, distance capability, weight capacity, available routes, and environmental operating requirements to output a transportation type recommendation comprising the one or more recommended transport carrier modalities.

In step 314, the processing server 104 (e.g., via the Manifest Engine 240) receives the transportation type recommendation and generates a transit profile 210 for each recommended transport carrier modality. Each transit profile 210 can include at least the payload origin, the payload destination, one or more intermediate stops, and for each leg of the route, an assigned transport carrier modality. The processing server 104 considers operator hours of service, physical limitations, energy management requirements, environmental requirements, and infrastructure requirements in generating each transit profile. The processing server 104 stores each generated transit profile as a transit profile 210 in the database 206.

In step 316, the processing server 104 (e.g., via the AI Engine 242) processes each transit profile with corresponding real-time data for each recommended transport carrier modality. The real-time data includes at least transport carrier modality demographics, traffic patterns, and regulatory inputs obtained from the external data sources 110A-110N via the receiving device 202. The processing server 104 inputs the recommended transport carrier modalities with the corresponding real-time data into the trained AI model stored in the database 206 and generates a proximity matrix of distances and pathways between the payload origin and the payload destination bounded by infrastructure and geography constraints.

In step 318, the processing server 104 (e.g., via the trained AI model executed by the AI Engine 242) outputs an optimized payload transport solution for each recommended transport carrier modality. The processing server 104 seeks the most efficient or cost-effective distribution considering all boundary conditions across homogeneous and heterogeneous transit modalities, including risk to safety, schedule, and costs associated with transloading freight between intermodal vehicles.

In step 320, the processing server 104 (e.g., via the Cost Engine 244) receives transit profile data and optimized payload transport solution data and determines one or more parameters that influence the costs of deploying physical and human assets, including base transportation costs, fuel surcharges, energy costs, operator labor costs, equipment costs, and lifecycle costs. The processing server 104 generates interim cost data comprising at least profit margins, cost risks, fuel surcharge calculations, and lifecycle cost assessments. The processing server 104 (e.g., via the Pricing Engine 246) receives the interim cost data and calculates rate estimates for LTL and TL shipments, including all accessorials identified by the Accessorials Engine 236, and produces a final price for each transit profile.

In step 322, the processing server 104 (e.g., via the Transport Gap Engine 248) examines the transit profiles and the optimized payload transport solutions to identify one or more transport gaps. A transport gap comprises a leg of the transit profile for which no single transport carrier modality is capable of providing transport service due to at least one of a constraint on time, infrastructure, or price. If one or more transport gaps are identified at step 324, the process proceeds to step 326, where the processing server 104 (e.g., via the AI Engine 242) generates an intermodal transfer solution that assigns a replacement transport carrier modality to each identified transport gap leg while optimizing for minimum schedule delay and minimum cost. The processing server 104 (e.g., via the Manifest Engine 240) updates the transit profile 210 in the database 206 to incorporate the intermodal transfer solution, and the process returns to step 316 for re-processing until a transit profile with zero transport gaps is produced. If no transport gaps are identified at step 324, the process proceeds to step 328.

In step 328, the processing server 104 (e.g., via the Operations Engine 250) evaluates operational feasibility of the transit profile by considering IoT device availability, infrastructure availability, environmental factors, regulatory compliance requirements, and human resource availability. If the processing server 104 identifies operational feasibility issues at step 330, the issues are fed back to the AI Engine 242 for re-optimization and the process returns to step 316. If operational feasibility is confirmed at step 330, the process proceeds to step 332.

In step 332, the processing server 104 compares the optimized payload transport solution for each recommended transport carrier modality to the shipping order and generates an optimized logistics solution for the payload, the optimized logistics solution including at least transport carrier assignments, routing instructions, and scheduling parameters. The processing server 104 stores the optimized logistics solution in the database 206 in association with the corresponding transit profile 210 and shipping order.

In step 334, the processing server 104 (e.g., via the Contracts Engine 252) receives the results from the Pricing Engine 246 and the Operations Engine 250 and automatically generates contract rate agreements for each party involved in the optimized logistics solution. The processing server 104 incorporates pricing, accessorials, operational requirements, and transport carrier assignments into the contract terms. The processing server 104 stores the generated contract records in the database 206.

In step 336, the processing server 104 (e.g., via the Documents Engine 254) prepares electronic contract documents based on the contract terms and transmits the electronic contract documents via the transmitting device 222 over the communication network to one or more party devices (e.g., user computing devices 102A-102N and transport carrier servers 106A-106N) for electronic signature. In embodiments, the processing server 104 further generates additional transit documents including Bills of Lading, shipping manifests, customs declarations, and other regulatory documents.

In step 338, dependent upon contract terms and the receipt of executed electronic signatures, the processing server 104 (e.g., via the Finance Engine 256) executes one or more automated financial transactions based on the contract terms, including at least one of EDI transactions and ACH transactions. In embodiments, the processing server 104 escrows funds for all individual parties prior to dispatch. The processing server 104 records all financial transaction records in the database 206.

In step 340, the processing server 104 (e.g., via the Distribution Engine 260) distributes the final manifest, required transit documents, and access credentials to the appropriate parties via the transmitting device 222 over the communication network. The processing server 104 transmits electronic dispatch instructions to the transport carrier servers 106A-106N and, where applicable, directly to the transport carrier vehicles 108A-108N.

In step 342, the processing server 104 (e.g., via the Enroute Engine 262) receives, via the receiving device 202 over the communication network, real-time operational data from the one or more IoT devices physically interfaced with the ECU or PCM of the dispatched transport carrier vehicles 108A-108N. The real-time operational data comprises at least one of vehicle diagnostic data, operator control inputs, positional data, incipient failure signals, environmental sensor data, and autonomous control inputs. The processing server 104 assesses the real-time operational data in the context of the active transit profile 210 stored in the database 206, evaluating transit status, incipient failures, unforeseen contingencies, and projected schedules.

In step 344, the processing server 104 (e.g., via the Enroute Engine 262) determines whether a potential deviation from the shipping order requirements has been detected based on the real-time operational data. If no deviation is detected at step 344, the process returns to step 342 to continue monitoring real-time operational data. If a deviation is detected at step 344, the process proceeds to step 346.

In step 346, the processing server 104 (e.g., via the Change Engine 264) receives the relevant real-time operational data items from the Enroute Engine 262 and performs preprocessing, including data normalization, filtering, and structuring. The processing server 104 submits the preprocessed data to the AI Engine 268.

In step 348, the processing server 104 (e.g., via the AI Engine 268) decomposes the real-time operational data into a plurality of influence-variable matrices using at least one data manipulation technique selected from the group consisting of Singular Value Decomposition, Markov models, and neural networks. The processing server 104 applies pattern recognition to the plurality of influence-variable matrices to identify a logistics gap condition comprising at least one of a schedule deviation, an infrastructure constraint, an incipient vehicle failure, or a contested logistics scenario.

In step 350, the processing server 104 (e.g., via the AI Engine 268) generates a corrective routing action in response to the identified logistics gap condition. The corrective routing action comprises at least one of a re-routing instruction, a modality substitution recommendation, and a load manifest revision. The processing server 104 generates the corrective routing action by feeding the plurality of influence-variable matrices back through the trained AI model via the computational feedback loop illustrated in FIG. 2E.

In step 352, the processing server 104 (e.g., via the Contracts Engine 252) automatically updates the contract terms stored in the database 206 to reflect the corrective routing action. The processing server 104 (e.g., via the Documents Engine 254) generates updated electronic contract documents, the processing server 104 (e.g., via the Finance Engine 256) executes any additional or revised financial transactions, and the processing server 104 (e.g., via the Distribution Engine 260) distributes a revised manifest and alert notifications to all affected parties.

In step 354, the processing server 104 (e.g., via the transmitting device 222) transmits the corrective routing action as an electronic control signal via the Communications module 258 to the transport carrier vehicle 108A-108N over at least one communication channel selected from the group consisting of a WAN, a 4G/5G cellular network, Wi-Fi, UHF, and Bluetooth Low Energy. The one or more IoT devices of the transport carrier vehicle 108A-108N receive the electronic control signal and, where authorized, write the corrective routing action to the ECU or PCM of the transport carrier vehicle via one or more hardware sensor buses. The revised solution is passed back into the Enroute Engine 262 at step 342 for continued monitoring.

In step 356, upon successful completion of payload transport, the processing server 104 (e.g., via the Enroute Engine 262) receives, via the receiving device 202, confirmation data from the transport carrier vehicle 108A-108N indicating delivery of the payload at the payload destination. The processing server 104 generates a proof of delivery record at Proof of Delivery 266 and stores the proof of delivery record in the database 206. The processing server 104 (e.g., via the Distribution Engine 260) transmits a proof of delivery notification to the user computing devices 102A-102N associated with the shipper and receiver via the transmitting device 222. In embodiments, the processing server 104 (e.g., via the Finance Engine 256) executes final financial transactions, including release of escrowed funds, upon confirmation of the proof of delivery.

In step 358, the processing server 104 collects resulting operational data generated during execution of the optimized logistics solution and stores the resulting operational data in the database 206 as part of the historical logistics datasets. The processing server 104 feeds the resulting operational data back into the trained AI model of the AI Engines 220 via the computational feedback loop illustrated in FIG. 2E, thereby continuously improving predictive accuracy of future optimized payload transport solutions.

### Exemplary Method for Autonomous Orchestration of Intermodal Logistics Transportation

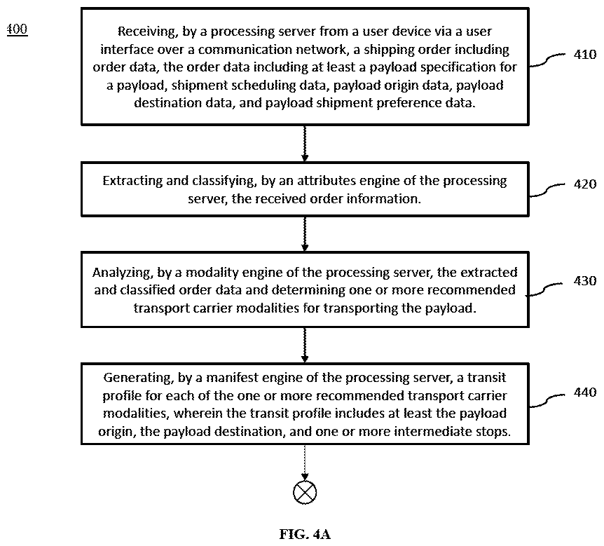

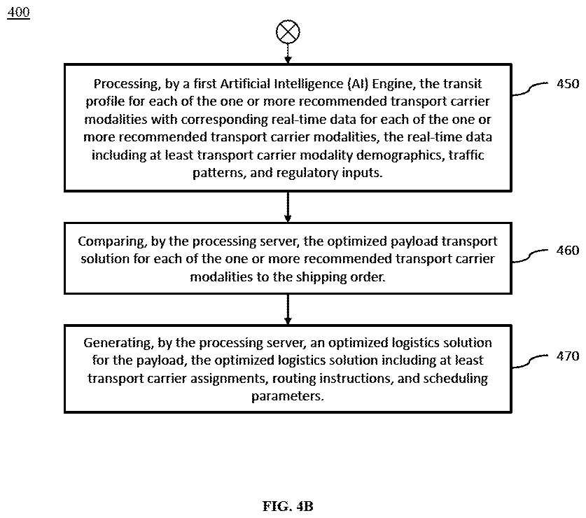

FIGS. 4A-4B illustrate method 400 for autonomous orchestration of intermodal logistics transportation in the system 100 of FIG. 1.

In step 410, a processing server (e.g., the processing server 104) receives, from a user device (e.g., a user computing device 102A) via a user interface over a communication network (e.g., the one or more communication networks of the system 100), a shipping order including order data. The order data can include at least a payload specification for a payload, shipment scheduling data, payload origin data, payload destination data, and payload shipment preference data. In embodiments, the processing server (e.g., the processing server 104) stores the shipping order in a database (e.g., the database 206) and queries client profiles (e.g., the client profiles 212) stored in the database to verify the identity and authorization of a user associated with the user device.

In step 420, the processing server (e.g., the processing server 104), via an attributes engine (e.g., the Attributes Engine 232), extracts and classifies the received order data. The attributes engine parses the shipping order stored in the database and extracts payload and transportation parameters, classifying the extracted parameters into categories corresponding to physical, operational, and regulatory attributes. In embodiments, the processing server receives supplemental attribute data from one or more external data sources (e.g., the external data sources 110A-110N), such as weather data, performance data, energy management data, and warehousing and storage data, and incorporates the supplemental attribute data into the extracted and classified order data.

In step 430, the processing server (e.g., the processing server 104), via a modality engine (e.g., the Modality Engine 238), analyzes the extracted and classified order data and determines one or more recommended transport carrier modalities for transporting the payload. In embodiments, the analyzing by the modality engine further comprises: the processing server querying a carrier modality database (e.g., the transport carrier profiles 208) storing a library of carrier modalities, the library comprising data records detailing physical, operational, and performance characteristics of a plurality of transport vehicles (e.g., the transport carrier vehicles 108A-108N) comprising a mixture of traditional and transformative electric and sustainable land, air, and water vehicles; comparing the payload specification against the data records and eliminating from transport consideration each transport vehicle having a data record indicating incapability of supporting the payload specification based on at least one of weight, size, volume, or distance; generating, by a first AI Engine (e.g., the AI Engine 242), a proximity matrix data structure comprising computed proximity distances and pathways between the payload origin and the payload destination using at least latitude and longitude coordinates, zip or postcode data, and relative bearing, the proximity matrix data structure bounded by infrastructure and geography constraints retrieved from one or more geospatial databases (e.g., of the external data sources 110A-110N); and determining, by the first AI Engine based on the proximity matrix data structure and remaining transport vehicle data records after the eliminating, the one or more recommended transport carrier modalities, wherein the determining comprises computing an optimized distribution of the one or more recommended transport carrier modalities across one or more legs of a transit profile that minimizes a combined cost function considering boundary conditions across homogeneous and heterogeneous transit modalities, the combined cost function incorporating risk to safety, schedule, and costs associated with transloading freight between intermodal vehicles.

In step 440, the processing server (e.g., the processing server 104), via a manifest engine (e.g., the Manifest Engine 240), generates a transit profile 210 for each of the one or more recommended transport carrier modalities. The transit profile 210 can include, for example, the payload origin, the payload destination, and one or more intermediate stops. In generating each transit profile, the processing server can consider one or more factors including, for example, operator hours of service, physical limitations of the assigned transport carrier vehicle, energy management requirements, environmental requirements, and infrastructure requirements. The processing server stores each generated transit profile (e.g., as a transit profile 210) in the database (e.g., the database 206).

In step 450, the processing server (e.g., the processing server 104), via a first Artificial Intelligence (AI) Engine (e.g., the AI Engine 242), processes the transit profile 210 for each of the one or more recommended transport carrier modalities with corresponding real-time data for each of the one or more recommended transport carrier modalities. The real-time data can include, for example, transport carrier modality demographics, traffic patterns, and regulatory inputs obtained from one or more external data sources (e.g., the external data sources 110A-110N). The processing can include: the processing server 104 inputting the one or more recommended transport carrier modalities with the corresponding real-time data into a trained AI model (e.g., the trained AI model stored in the database 206) configured to output an optimized payload transport solution for each of the one or more recommended transport carrier modalities; and the trained AI model outputting an optimized payload transport solution for each of the one or more recommended transport carrier modalities.

In embodiments, the processing by the first AI Engine further includes: the processing server 104 ingesting, via one or more application programming interfaces (APIs), the real-time data from a plurality of heterogeneous data sources (e.g., the external data sources 110A-110N) including, for example, vehicle telematics systems, traffic monitoring systems, and regulatory compliance databases; segmenting the ingested real-time data into a comprehensive data model comprising a plurality of influence-variable matrices stored in the database, the plurality of influence-variable matrices defining influence variables corresponding to operational, environmental, and regulatory parameters of the one or more recommended transport carrier modalities; and applying, via the trained AI model, at least one data manipulation technique selected from the group consisting of Singular Value Decomposition, Markov models, and neural networks to the plurality of influence-variable matrices to perform dimensionality reduction and data noise suppression, thereby reducing a computational resource requirement of the processing server for generating the optimized payload transport solution for each of the one or more recommended transport carrier modalities.

In step 460, the processing server (e.g., the processing server 104) compares the optimized payload transport solution for each of the one or more recommended transport carrier modalities to the shipping order.

In step 470, the processing server (e.g., the processing server 104) generates an optimized logistics solution for the payload. The optimized logistics solution includes at least transport carrier assignments, routing instructions, and scheduling parameters. The processing server stores the optimized logistics solution in the database (e.g., the database 206) in association with the corresponding transit profile and shipping order.

In embodiments of the method 400, the method 400 further includes the processing server (e.g., the processing server 104), via a Transport Gap Engine (e.g., the Transport Gap Engine 248), examining the transit profile for each of the one or more recommended transport carrier modalities to identify one or more transport gaps by computationally evaluating physical constraints of available transport vehicles against leg-specific requirements of the transit profile, wherein a transport gap comprises a leg of the transit profile for which no single transport carrier modality of the one or more recommended transport carrier modalities is capable of providing transport service due to at least one of a constraint on time, infrastructure, or price; in response to identifying the one or more transport gaps, the processing server inputting the one or more transport gaps and the transit profile into the trained AI model to generate an intermodal transfer solution that assigns a replacement transport carrier modality to each identified transport gap leg while optimizing for minimum schedule delay and minimum cost across all remaining legs of the transit profile; and the processing server (e.g., via the Manifest Engine 240) updating the transit profile stored in the database to incorporate the intermodal transfer solution, thereby producing a revised transit profile with zero transport gaps.

In embodiments of the method 400, the method 400 further includes the processing server (e.g., the processing server 104) receiving, via the communication network from one or more shipper devices and one or more load board systems, a plurality of load tenders, each load tender comprising a load type selected from pick only, pick and drop, and drop only, and associated accessorials and delivery requirements; for each load tender of the plurality of load tenders, the processing server sequentially inputting the load tender and one or more preceding load tenders into the trained AI model, wherein the trained AI model evaluates compatibility of each sequential load tender against boundary conditions including at least payload weight, payload volume, payload dimensions, delivery time windows, and regulatory compliance constraints, and wherein the evaluation progresses from a stochastic analysis to a deterministic analysis as boundary conditions of each sequential load tender are imposed; the processing server generating a maximum capacity loading manifest stored in the database, the maximum capacity loading manifest assigning the plurality of load tenders across one or more transport vehicles of the one or more recommended transport carrier modalities; and the processing server transmitting, via the communication network, the maximum capacity loading manifest to one or more carrier devices (e.g., transport carrier servers 106A-106N) associated with the one or more transport vehicles.

In embodiments of the method 400, the method 400 further includes the processing server (e.g., the processing server 104) collecting, via the communication network, resulting operational data generated during execution of the optimized logistics solution, the resulting operational data comprising at least one of actual transit times, actual fuel consumption, actual route deviations, and actual delivery completion timestamps; the processing server feeding the resulting operational data back into the trained AI model as training input via a computational feedback loop (e.g., the computational feedback loop illustrated in FIG. 2E) implemented on the processing server, the computational feedback loop comprising: updating a training dataset stored in the database by appending the resulting operational data to historical logistics datasets, and retraining or fine-tuning the trained AI model using the updated training dataset to improve predictive accuracy of future optimized payload transport solutions; and processing, by the trained AI model in response to receiving the resulting operational data, one or more real-time adjustments to the optimized logistics solution, the one or more real-time adjustments comprising proactive corrections that automatically resolve unforeseen contingencies including contested logistics scenarios in which an adversarial disruption, delay, or discontinuation of any portion of a supply chain is detected; and the processing server transmitting, via the communication network, the one or more real-time adjustments to one or more carrier devices, shipper devices, or receiver devices associated with the optimized logistics solution.

In embodiments of the method 400, the method 400 further includes the processing server (e.g., the processing server 104) dispatching, via the communication network, electronic dispatch instructions to a transport vehicle (e.g., a transport carrier vehicle 108A) in accordance with the optimized logistics solution; the processing server (e.g., via the Enroute Engine 262) receiving, via the communication network from one or more Internet of Things (IoT) devices physically interfaced with an Electronic Control Unit (ECU) or Powertrain Control Module (PCM) of the transport vehicle, real-time operational data comprising at least one of vehicle diagnostic data, operator control inputs, positional data, incipient failure signals, and environmental sensor data, wherein the one or more IoT devices obtain the real-time operational data by reading electronic signals from one or more sensor buses of the transport vehicle; the processing server (e.g., via the AI Engine 268) decomposing the real-time operational data into a plurality of influence-variable matrices using at least one data manipulation technique selected from the group consisting of Singular Value Decomposition, Markov models, and neural networks, wherein the decomposing reduces dimensionality of the real-time operational data and separates deterministic operational variables from stochastic environmental variables; the processing server (e.g., via the AI Engine 268) identifying, via pattern recognition applied to the plurality of influence-variable matrices, a logistics gap condition comprising a deviation between the transit profile and one or more requirements of the shipping order, the logistics gap condition comprising at least one of a schedule deviation, an infrastructure constraint, and an incipient vehicle failure; the processing server (e.g., via the Change Engine 264) submitting the plurality of influence-variable matrices to the AI Engine 268 to determine an impact of the identified logistics gap condition and to generate a corrective routing action, wherein the corrective routing action comprises at least one of a re-routing instruction, a modality substitution recommendation, and a load manifest revision; and the processing server transmitting the corrective routing action as an electronic control signal via at least one communication channel to the transport vehicle, wherein the at least one communication channel is selected from the group consisting of a wide area network (WAN), a 4G/5G cellular network, Wi-Fi, UHF, and Bluetooth Low Energy.

In such embodiments, the one or more IoT devices may comprise onboard processing capability, multi-band full-duplex communications, and analog and digital input/output interfaces electrically connected to the ECU of the transport vehicle via one or more hardware sensor buses. In such embodiments, the method 400 may further include the processing server (e.g., via the transmitting device 222) transmitting the corrective routing action to the one or more IoT devices as a closed-loop feedback control instruction, wherein the one or more IoT devices write the closed-loop feedback control instruction to the ECU of the transport vehicle via the one or more hardware sensor buses, thereby enabling autonomous operations of the transport vehicle including Beyond Visual Line of Sight (BVLOS) capabilities without requiring human operator intervention; and the processing server (e.g., via the Enroute Engine 262) receiving, via the one or more IoT devices over the at least one communication channel, confirmation data read from the ECU of the transport vehicle indicating execution of the corrective routing action by the transport vehicle.

In such embodiments, the method 400 may further include the processing server (e.g., via the Contracts Engine 252) automatically updating contract terms stored in the database and associated with the transit profile to reflect the corrective routing action; the processing server (e.g., via the Documents Engine 254) generating updated electronic contract documents based on the updated contract terms and transmitting the updated electronic contract documents via the communication network to one or more party devices for electronic signature; the processing server (e.g., via the Finance Engine 256) executing one or more automated financial transactions based on the updated contract terms, the one or more automated financial transactions comprising at least one of an Electronic Data Interchange (EDI) transaction and an Automated Clearing House (ACH) transaction; and the processing server (e.g., via the Distribution Engine 260) distributing a revised manifest and electronic alert notifications regarding the corrective routing action to one or more devices associated with one or more of a carrier, a broker, a shipper, and a receiver.

In such embodiments, receiving the real-time operational data from the one or more IoT devices may comprise: ingesting, by the one or more IoT devices, raw sensor data from the one or more sensor buses of the transport vehicle via at least one vehicle communication protocol selected from the group consisting of CANbus, Modbus, MQTT, LoRaWAN, Bluetooth Low Energy (BLE), Wi-Fi, and Zigbee/Z-Wave; processing, by an onboard processor of the one or more IoT devices, the ingested raw sensor data at an edge processing layer to perform data fusion and filtering within dynamic operational constraints prior to transmitting the real-time operational data to the processing server, thereby reducing data transmission bandwidth between the transport vehicle and the processing server; and transmitting, by the one or more IoT devices, the processed real-time operational data to the processing server via at least one wide-area communication band selected from the group consisting of EHF, UHF ISM band, cellular, and satellite frequency bands; wherein the AI Engine 268 integrates the processed real-time operational data with cloud-stored logistics data retrieved from the database to execute the pattern recognition applied to the plurality of influence-variable matrices.

While the foregoing description of the method 400 includes the example of one or more engines and modules of the processing server 104 performing the steps of the method 400, it can be appreciated that the processor 214 of the processing server 104 executes the instructions of the logistics optimization program 218 to carry out the steps in such example.

### Computer System Architecture

FIG. 5 illustrates computer system 500 in which embodiments of the present disclosure, or portions thereof, can be implemented as computer-readable code. For example, the user computing devices 102A-102N, the processing server 104A-104N, the transport carrier servers 106A-106N, and/or the external data sources 110A-110N can be implemented in the computer system 500 using hardware, non-transitory computer readable media having instructions stored thereon, or a combination thereof and can be implemented in one or more computer systems or other processing systems. Hardware can embody modules and components used to implement the processes and methods of FIGS. 3A-4B.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general-purpose processor device specifically configured to perform the functions discussed herein. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to people having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 700, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to people having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be a means of providing software for the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the processes and methods illustrated by FIGS. 3A-4B, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower-level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 500 to perform the functions disclosed herein. It will be apparent to people having skill in the relevant art that such processes result in the computer system 500 being a specially configured computer system 500 uniquely programmed to perform the functions discussed above.

Techniques consistent with the present disclosure provide, among other features, systems and methods for autonomous orchestration of intermodal logistics transportation. While various exemplary embodiments of the disclosed systems and methods have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for autonomous orchestration of intermodal logistics transportation, the method comprising:
receiving, by a processing server from a user device via a user interface over a communication network, a shipping order including order data, the order data including at least a payload specification for a payload, shipment scheduling data, payload origin data, payload destination data, and payload shipment preference data;
extracting and classifying, by an attributes engine of the processing server, the received order data;
analyzing, by a modality engine of the processing server, the extracted and classified order data and determining one or more recommended transport carrier modalities for transporting the payload;
generating, by a manifest engine of the processing server, a transit profile for each of the one or more recommended transport carrier modalities, wherein the transit profile includes at least the payload origin, the payload destination, and one or more intermediate stops;
processing, by a first Artificial Intelligence (AI) Engine, the transit profile for each of the one or more recommended transport carrier modalities with corresponding real-time data for each of the one or more recommended transport carrier modalities, the real-time data including at least transport carrier modality demographics, traffic patterns, and regulatory inputs, the processing by the first AI Engine including:
inputting, by the processing server, the one or more recommended transport carrier modalities with the corresponding real-time data into a trained AI model configured to output an optimized payload transport solution for each of the one or more recommended transport carrier modalities;
outputting, by the trained AI model, an optimized payload transport solution for each of the one or more recommended transport carrier modalities;
comparing, by the processing server, the optimized payload transport solution for each of the one or more recommended transport carrier modalities to the shipping order; and
generating, by the processing server, an optimized logistics solution for the payload, the optimized logistics solution including at least transport carrier assignments, routing instructions, and scheduling parameters.

2. The method of claim 1, wherein the processing by the first AI Engine further comprises:
ingesting, by the processing server via one or more application programming interfaces (APIs), the real-time data from a plurality of heterogeneous data sources including at least one of: vehicle telematics systems, traffic monitoring systems, and regulatory compliance databases;
segmenting, by the processing server, the ingested real-time data into a comprehensive data model comprising a plurality of influence-variable matrices that define influence variables corresponding to operational, environmental, and regulatory parameters of the one or more recommended transport carrier modalities; and
applying, by the trained AI model, a data manipulation technique to the plurality of influence-variable matrices to perform dimensionality reduction and data noise suppression to reduce a computational resource requirement for generating the optimized payload transport solution for each of the one or more recommended transport carrier modalities.

3. The method of claim 1, further comprising:
examining, by a transport gap engine of the processing server, the transit profile for each of the one or more recommended transport carrier modalities to identify one or more transport gaps by computationally evaluating physical constraints of available transport vehicles against leg-specific requirements of the transit profile, wherein a transport gap comprises a leg of the transit profile for which no single transport carrier modality of the one or more recommended transport carrier modalities is capable of providing transport service due to at least one of a constraint on time, infrastructure, or price;
in response to identifying the one or more transport gaps, inputting, by the processing server, the one or more transport gaps and the transit profile into the trained AI model to generate an intermodal transfer solution that assigns a replacement transport carrier modality to each identified transport gap leg while optimizing for minimum schedule delay and minimum cost across all remaining legs of the transit profile; and
updating, by the manifest engine of the processing server, the transit profile stored in a database of the processing server to incorporate the intermodal transfer solution.

4. The method of claim 1, further comprising:
receiving, by the processing server via the communication network from one or more shipper devices and one or more load board systems, a plurality of load tenders, each load tender comprising a load type, associated accessorials, and delivery requirements;
for each load tender of the plurality of load tenders, sequentially inputting, by the processing server, the load tender and one or more preceding load tenders into the trained AI model, wherein the trained AI model evaluates compatibility of each sequential load tender against boundary conditions including at least payload weight, payload volume, payload dimensions, delivery time windows, and regulatory compliance constraints;
generating, by the trained AI model, a maximum capacity loading manifest, the maximum capacity loading manifest assigning the plurality of load tenders across one or more transport vehicles of the one or more recommended transport carrier modalities; and
transmitting, by the processing server via the communication network, the maximum capacity loading manifest to one or more carrier devices associated with the one or more transport vehicles.

5. The method of claim 1, further comprising:
collecting, by the processing server via the communication network, resulting operational data generated during execution of the optimized logistics solution, the resulting operational data including at least one of: actual transit times, actual fuel consumption, actual route deviations, and actual delivery completion timestamps;
feeding, by the processing server, the resulting operational data back into the trained AI model as training input via a computational feedback loop implemented on the processing server, the computational feedback loop comprising:
updating a training dataset stored in a database of the processing server by appending the resulting operational data to historical logistics datasets, and retraining or fine-tuning the trained AI model using the updated training dataset to improve predictive accuracy of future optimized payload transport solutions; and
processing, by the trained AI model in response to receiving the resulting operational data, one or more real-time adjustments to the optimized logistics solution; and
transmitting, by the processing server via the communication network, the one or more real-time adjustments to one or more carrier devices, shipper devices, or receiver devices associated with the optimized logistics solution.

6. The method of claim 1, further comprising:
dispatching, by the processing server via the communication network, electronic dispatch instructions to a transport vehicle in accordance with the optimized logistics solution;
receiving, by an enroute engine of the processing server via the communication network from one or more Internet of Things (IoT) devices physically interfaced with an Electronic Control Unit (ECU) or Powertrain Control Module (PCM) of the transport vehicle, real-time operational data;
decomposing, by a second AI engine of the processing server, the real-time operational data into a plurality of influence-variable matrices using at least one data manipulation technique;
identifying, by the second AI engine via pattern recognition applied to the plurality of influence-variable matrices, a logistics gap condition, the logistics gap condition including one or more of: a deviation between the transit profile and one or more requirements of the shipping order, the logistics gap condition comprising at least one of a schedule deviation, an infrastructure constraint, and an incipient vehicle failure;
submitting, by a change engine of the processing server, the plurality of influence-variable matrices to the second AI Engine to determine an impact of the identified logistics gap condition and to generate a corrective routing action, wherein the corrective routing action comprises at least one of: a re-routing instruction, a modality substitution recommendation, and a load manifest revision; and
transmitting, by the processing server, the corrective routing action as an electronic control signal via at least one communication channel to the transport vehicle.

7. The method of claim 6, wherein the one or more IoT devices include onboard processing capability, multi-band full-duplex communications, and analog and digital input/output interfaces electrically connected to the ECU of the transport vehicle via one or more hardware sensor buses, the method further comprising:
transmitting, by the processing server via the at least one communication channel, the corrective routing action to the one or more IoT devices as a closed-loop feedback control instruction, wherein the one or more IoT devices write the closed-loop feedback control instruction to the ECU of the transport vehicle via the one or more hardware sensor buses; and
receiving, by the enroute engine via the one or more IoT devices over the at least one communication channel, confirmation data read from the ECU of the transport vehicle indicating execution of the corrective routing action by the transport vehicle.

8. The method of claim 6, further comprising:
in response to generating the corrective routing action, automatically updating, by a contracts engine of the processing server, contract terms stored in a contracts database of the processing server and associated with the transit profile to reflect the corrective routing action;
generating, by a documents engine of the processing server, updated electronic contract documents based on the updated contract terms and transmitting the updated electronic contract documents via the communication network to one or more party devices for electronic signature;
executing, by a finance engine of the processing server via the communication network, one or more automated financial transactions based on the updated contract terms, the one or more automated financial transactions comprising at least one of an Electronic Data Interchange (EDI) transaction and an Automated Clearing House (ACH) transaction; and
distributing, by a distribution engine of the processing server via the communication network, a revised manifest and electronic alert notifications regarding the corrective routing action to one or more devices associated with one or more of a carrier, a broker, a shipper, and a receiver.

9. The method of claim 1, wherein the analyzing by the modality engine further comprises:
querying, by the processing server, a carrier modality database storing a library of carrier modalities, the library comprising data records detailing physical, operational, and performance characteristics of a plurality of transport vehicles;
comparing, by the processing server, the payload specification against the data records of the carrier modality database and eliminating from transport consideration each transport vehicle having a data record indicating incapability of supporting the payload specification based on at least one of weight, size, volume, or distance;
generating, by the first AI engine, a proximity matrix data structure including computed proximity distances and pathways between the payload origin and the payload destination using at least latitude and longitude coordinates, zip or postcode data, and relative bearing, the proximity matrix data structure bounded by infrastructure and geography constraints retrieved from one or more geospatial databases; and
determining, by the first AI engine based on the proximity matrix data structure and remaining transport vehicle data records after the eliminating, the one or more recommended transport carrier modalities, wherein the determining includes:
computing an optimized distribution of the one or more recommended transport carrier modalities across one or more legs of the transit profile that minimizes a combined cost function considering boundary conditions across homogeneous and heterogeneous transit modalities, the combined cost function incorporating risk to safety, schedule, and costs associated with transloading freight between intermodal vehicles.

10. The method of claim 6, wherein receiving the real-time operational data from the one or more IoT devices comprises:
ingesting, by the one or more IoT devices, raw sensor data from one or more sensor buses of the transport vehicle via at least one vehicle communication protocol;
processing, by an onboard processor of the one or more IoT devices, the ingested raw sensor data at an edge processing layer to perform data fusion and filtering within dynamic operational constraints prior to transmitting the real-time operational data to the processing server; and
transmitting, by the one or more IoT devices, the processed real-time operational data to the processing server via at least one wide-area communication band,
wherein the second AI engine integrates the processed real-time operational data with cloud-stored logistics data retrieved from a database of the processing server to execute the pattern recognition applied to the plurality of influence-variable matrices.

11. A system for autonomous orchestration of intermodal logistics transportation, the system comprising:
a communication network;
a user device configured to transmit, via the communication network, a shipping order including order data, the order data including at least a payload specification for a payload, shipment scheduling data, payload origin data, payload destination data, and payload shipment preference data;
a processing server communicatively coupled to the user device via the communication network, the processing server comprising one or more processors and one or more non-transitory computer-readable storage media storing instructions that, when executed by the one or more processors, cause the processing server to:
receive, from the user device via a user interface over the communication network, the shipping order;
extract and classify, by an attributes engine executed by the one or more processors, the received order data;
analyze, by a modality engine executed by the one or more processors, the extracted and classified order data and determine one or more recommended transport carrier modalities for transporting the payload;
generate, by a manifest engine executed by the one or more processors, a transit profile for each of the one or more recommended transport carrier modalities, wherein the transit profile includes at least the payload origin, the payload destination, and one or more intermediate stops;
process, by a first Artificial Intelligence (AI) Engine executed by the one or more processors, the transit profile for each of the one or more recommended transport carrier modalities with corresponding real-time data for each of the one or more recommended transport carrier modalities, the real-time data including at least transport carrier modality demographics, traffic patterns, and regulatory inputs, the processing by the first AI Engine comprising:
inputting the one or more recommended transport carrier modalities with the corresponding real-time data into a trained AI model stored on the one or more non-transitory computer-readable storage media, the trained AI model configured to output an optimized payload transport solution for each of the one or more recommended transport carrier modalities;
outputting, by the trained AI model, an optimized payload transport solution for each of the one or more recommended transport carrier modalities;
comparing the optimized payload transport solution for each of the one or more recommended transport carrier modalities to the shipping order; and
generating an optimized logistics solution for the payload, the optimized logistics solution including at least transport carrier assignments, routing instructions, and scheduling parameters; and
a database communicatively coupled to the processing server and configured to store the shipping order, the transit profile, the trained AI model, and the optimized logistics solution.

12. The system of claim 11, wherein the one or more non-transitory computer-readable storage media further store instructions that, when executed by the one or more processors, cause the processing server to:
ingest, via one or more application programming interfaces (APIs), the real-time data from a plurality of heterogeneous data sources including at least one of: vehicle telematics systems, traffic monitoring systems, and regulatory compliance databases;
segment the ingested real-time data into a comprehensive data model comprising a plurality of influence-variable matrices that define influence variables corresponding to operational, environmental, and regulatory parameters of the one or more recommended transport carrier modalities; and
apply, via the trained AI model, a data manipulation technique to the plurality of influence-variable matrices to perform dimensionality reduction and data noise suppression to reduce a computational resource requirement of the one or more processors for generating the optimized payload transport solution for each of the one or more recommended transport carrier modalities.

13. The system of claim 11, wherein the one or more non-transitory computer-readable storage media further store instructions that, when executed by the one or more processors, cause the processing server to:
examine, by a transport gap engine executed by the one or more processors, the transit profile for each of the one or more recommended transport carrier modalities to identify one or more transport gaps by computationally evaluating physical constraints of available transport vehicles against leg-specific requirements of the transit profile, wherein a transport gap comprises a leg of the transit profile for which no single transport carrier modality of the one or more recommended transport carrier modalities is capable of providing transport service due to at least one of a constraint on time, infrastructure, or price;
in response to identifying the one or more transport gaps, input the one or more transport gaps and the transit profile into the trained AI model to generate an intermodal transfer solution that assigns a replacement transport carrier modality to each identified transport gap leg while optimizing for minimum schedule delay and minimum cost across all remaining legs of the transit profile; and
update, by the manifest engine, the transit profile stored in the database to incorporate the intermodal transfer solution.

14. The system of claim 11, wherein the one or more non-transitory computer-readable storage media further store instructions that, when executed by the one or more processors, cause the processing server to:
receive, via the communication network from one or more shipper devices and one or more load board systems, a plurality of load tenders, each load tender comprising a load type, associated accessorials, and delivery requirements;
for each load tender of the plurality of load tenders, sequentially input the load tender and one or more preceding load tenders into the trained AI model, wherein the trained AI model evaluates compatibility of each sequential load tender against boundary conditions including at least payload weight, payload volume, payload dimensions, delivery time windows, and regulatory compliance constraints;
generate a maximum capacity loading manifest, the maximum capacity loading manifest assigning the plurality of load tenders across one or more transport vehicles of the one or more recommended transport carrier modalities; and
transmit, via the communication network, the maximum capacity loading manifest to one or more carrier devices associated with the one or more transport vehicles.

15. The system of claim 11, wherein the one or more non-transitory computer-readable storage media further store instructions that, when executed by the one or more processors, cause the processing server to:
collect, via the communication network, resulting operational data generated during execution of the optimized logistics solution, the resulting operational data including at least one of: actual transit times, actual fuel consumption, actual route deviations, and actual delivery completion timestamps;
feed the resulting operational data back into the trained AI model as training input via a computational feedback loop implemented on the processing server, the computational feedback loop comprising:
updating a training dataset stored in the database by appending the resulting operational data to historical logistics datasets, and retraining or fine-tuning the trained AI model using the updated training dataset to improve predictive accuracy of future optimized payload transport solutions; and
processing, by the trained AI model in response to receiving the resulting operational data, one or more real-time adjustments to the optimized logistics solution; and
transmit, via the communication network, the one or more real-time adjustments to one or more carrier devices, shipper devices, or receiver devices associated with the optimized logistics solution.

16. The system of claim 11, further comprising:
one or more Internet of Things (IoT) devices physically interfaced with an Electronic Control Unit (ECU) or Powertrain Control Module (PCM) of a transport vehicle, the one or more IoT devices configured to transmit real-time operational data to the processing server via the communication network;
wherein the one or more non-transitory computer-readable storage media further store instructions that, when executed by the one or more processors, cause the processing server to:
dispatch, via the communication network, electronic dispatch instructions to the transport vehicle in accordance with the optimized logistics solution;
receive, by an enroute engine executed by the one or more processors, the real-time operational data from the one or more IoT devices via the communication network;
decompose, by a second AI engine executed by the one or more processors, the real-time operational data into a plurality of influence-variable matrices using at least one data manipulation technique;
identify, by the second AI engine via pattern recognition applied to the plurality of influence-variable matrices, a logistics gap condition, the logistics gap condition including one or more of: a deviation between the transit profile and one or more requirements of the shipping order, the logistics gap condition comprising at least one of a schedule deviation, an infrastructure constraint, and an incipient vehicle failure;
submit, by a change engine executed by the one or more processors, the plurality of influence-variable matrices to the second AI engine to determine an impact of the identified logistics gap condition and to generate a corrective routing action, wherein the corrective routing action comprises at least one of: a re-routing instruction, a modality substitution recommendation, and a load manifest revision; and
transmit the corrective routing action as an electronic control signal via at least one communication channel to the transport vehicle.

17. The system of claim 16, wherein the one or more IoT devices include onboard processing capability, multi-band full-duplex communications, and analog and digital input/output interfaces electrically connected to the ECU of the transport vehicle via one or more hardware sensor buses, and wherein the one or more non-transitory computer-readable storage media further store instructions that, when executed by the one or more processors, cause the processing server to:
transmit, via the at least one communication channel, the corrective routing action to the one or more IoT devices as a closed-loop feedback control instruction, wherein the one or more IoT devices write the closed-loop feedback control instruction to the ECU of the transport vehicle via the one or more hardware sensor buses; and
receive, by the enroute engine via the one or more IoT devices over the at least one communication channel, confirmation data read from the ECU of the transport vehicle indicating execution of the corrective routing action by the transport vehicle.

18. The system of claim 16, wherein the one or more non-transitory computer-readable storage media further store instructions that, when executed by the one or more processors, cause the processing server to:
in response to generating the corrective routing action, automatically update, by a contracts engine executed by the one or more processors, contract terms stored in a contracts database of the processing server and associated with the transit profile to reflect the corrective routing action;
generate, by a documents engine executed by the one or more processors, updated electronic contract documents based on the updated contract terms and transmit the updated electronic contract documents via the communication network to one or more party devices for electronic signature;
execute, by a finance engine executed by the one or more processors via the communication network, one or more automated financial transactions based on the updated contract terms, the one or more automated financial transactions comprising at least one of an Electronic Data Interchange (EDI) transaction and an Automated Clearing House (ACH) transaction; and
distribute, by a distribution engine executed by the one or more processors via the communication network, a revised manifest and electronic alert notifications regarding the corrective routing action to one or more devices associated with one or more of a carrier, a broker, a shipper, and a receiver.

19. The system of claim 11, wherein the one or more non-transitory computer-readable storage media further store instructions that, when executed by the one or more processors, cause the processing server to:
query a carrier modality database storing a library of carrier modalities, the library comprising data records detailing physical, operational, and performance characteristics of a plurality of transport vehicles;
compare the payload specification against the data records of the carrier modality database and eliminate from transport consideration each transport vehicle having a data record indicating incapability of supporting the payload specification based on at least one of weight, size, volume, or distance;
generate, by the first AI engine, a proximity matrix data structure including computed proximity distances and pathways between the payload origin and the payload destination using at least latitude and longitude coordinates, zip or postcode data, and relative bearing, the proximity matrix data structure bounded by infrastructure and geography constraints retrieved from one or more geospatial databases; and
determine, by the first AI engine based on the proximity matrix data structure and remaining transport vehicle data records after the eliminating, the one or more recommended transport carrier modalities, wherein the determining includes:
computing an optimized distribution of the one or more recommended transport carrier modalities across one or more legs of the transit profile that minimizes a combined cost function considering boundary conditions across homogeneous and heterogeneous transit modalities, the combined cost function incorporating risk to safety, schedule, and costs associated with transloading freight between intermodal vehicles.

20. The system of claim 16, wherein receiving the real-time operational data from the one or more IoT devices comprises:
ingesting, by the one or more IoT devices, raw sensor data from one or more sensor buses of the transport vehicle via at least one vehicle communication protocol;
processing, by an onboard processor of the one or more IoT devices, the ingested raw sensor data at an edge processing layer to perform data fusion and filtering within dynamic operational constraints prior to transmitting the real-time operational data to the processing server; and
transmitting, by the one or more IoT devices, the processed real-time operational data to the processing server via at least one wide-area communication band;
wherein the second AI engine integrates the processed real-time operational data with cloud-stored logistics data retrieved from the database to execute the pattern recognition applied to the plurality of influence-variable matrices.
